(19) United States
(12) Patent Application Publication
(10) Pub. No.: US 2023/0296510 A1
(43) Pub. Date: Sep. 21, 2023

(54) SYSTEM AND METHOD FOR SEPARATING VOLUMETRIC AND SURFACE SCATTERING OF OPTICAL COMPONENT

(71) Applicant: Meta Platforms Technologies, LLC, Menlo Park, CA (US)

(72) Inventor: Jian XU, Redmond, WA (US)

(21) Appl. No.: 17/733,985

(22) Filed: Apr. 29, 2022

Related U.S. Application Data
(60) Provisional application No. 63/320,568, filed on Mar. 16, 2022.

(51) Int. Cl. G01N 21/47

(52) U.S. Cl. CPC G01N 21/4788; G01N 2021/479; G01N 2021/4704; G01N 2021/1765

(57) ABSTRACT

A system includes a light source configured to emit a probing beam to illuminate an optical element, and a rotating structure to which the optical element is mounted. The system also includes a controller configured to control the rotating structure to rotate to change a tilt angle of the optical element with respect to a propagation direction of the probing beam. The system also includes an image sensor configured to receive one or more scattered beams output from the optical element illuminated by the probing beam, and generate a plurality of sets of speckle pattern image data when the optical element is arranged at a plurality of tilt angles within a predetermined tilting range. The controller is configured to process the plurality of sets of speckle pattern image data to determine respective weights of volumetric scattering and surface scattering in an overall scattering of the optical element.

### CROSS REFERENCE TO RELATED APPLICATION

This application claims the benefit of priority to U.S. Provisional Application No. 63/320,568, filed on Mar. 16, 2022. The content of the above-mentioned application is incorporated herein by reference in its entirety.

### TECHNICAL FIELD

The present disclosure generally relates to optical systems and methods and, more specifically, to a system and a method for separating volumetric scattering and surface scattering of an optical component.

### BACKGROUND

Typical optical components or elements scatter lights. Light scattering can include volumetric scattering and surface scattering. Volumetric scattering is often intrinsically material related, while surface scattering is often dependent on the smoothness or roughness of an interface between the optical component and the environment (e.g., air). Quantifying scattering of the optical components is often key for component/system level metrology to meet certain optical application requirements. To provide guidance for improving manufacturing processes, it is desirable to identify the scattering sources (e.g., whether the scattering is from a volume and/or surface of the optical component), and provide information on the relative contributions of volumetric scattering and surface scattering to the overall scattering of the optical components. For example, if the surface scattering is identified as the dominant scattering in an overall scattering of the optical component, in order to improve the quality of the optical component, one could polish (or provide other types of treatment for) the surfaces of the optical component. If the volumetric scattering is identified as the dominant scattering in the overall scattering of the optical component, to improve the quality of the optical component, one could adjust the material formulation or compositions to reduce the intrinsic material scattering.

### SUMMARY OF THE DISCLOSURE

Consistent with an aspect of the present disclosure, a system is provided. The system includes a light source configured to emit a probing beam to illuminate an optical element. The system also includes a rotating structure to which the optical element is mounted. The system also includes a controller configured to control the rotating structure to rotate to change a tilt angle of the optical element with respect to a propagation direction of the probing beam within a predetermined tilting range. The system also includes an image sensor configured to receive one or more scattered beams output from the optical element illuminated by the probing beam, and generate a plurality of sets of speckle pattern image data when the optical element is arranged at a plurality of tilt angles within the predetermined tilting range. The controller is configured to process the plurality of sets of speckle pattern image data to determine respective weights of volumetric scattering and surface scattering in an overall scattering of the optical element.

Consistent with another aspect of the present disclosure, a method is provided. The method includes illuminating, by a light source, an optical element mounted to a rotating structure with a probing beam. The method also includes controlling, by a controller, rotation of the rotating structure to change a tilt angle of the optical element with respect to a propagation direction of the probing beam within a predetermined tilting range. The method also includes generating, by an image sensor, a plurality of sets of speckle pattern image data when the optical element is arranged at a plurality of tilt angles within the predetermined tilting range. The method also includes processing, by the controller, the plurality of sets of speckle pattern image data to determine respective weights of volumetric scattering and surface scattering in an overall scattering of the optical element.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIGS. 1A and 1B illustrate schematic diagrams showing physical phenomenon of an optical memory effect;

FIG. 2A illustrates a schematic diagram of a near-eye display (“NED”), according to an embodiment of the present disclosure;

FIG. 2B illustrates a schematic cross sectional view of half of the NED shown in FIG. 2A, according to an embodiment of the present disclosure;

FIG. 3 illustrates a schematic diagram of a light guide display system, according to an embodiment of the present disclosure;

FIG. 4A illustrates a schematic diagram of a scattering measurement system, according to an embodiment of the present disclosure;

FIG. 4B illustrates a schematic diagram showing a tilt of a sample in the scattering measurement system of FIG. 4A in a counter-clockwise direction, according to an embodiment of the present disclosure;

FIG. 4C illustrates a schematic diagram showing a tilt of the sample in the scattering measurement system of FIG. 4A in a clockwise direction, according to an embodiment of the present disclosure;

FIG. 4D illustrates a correlation function of a speckle pattern recorded by an image sensor included the scattering measurement system shown in FIG. 4A with respect to a reference speckle pattern recorded by the image sensor, according to an embodiment of the present disclosure;

FIG. 4E illustrates a correlation function of another speckle pattern recorded by the image sensor with respect to a reference speckle pattern recorded by the image sensor, according to an embodiment of the present disclosure;

FIG. 4F illustrates a curve showing a relationship between a maximum correlation coefficient and a tilt angle of the sample, according to an embodiment of the present disclosure;

FIG. 5A illustrates a schematic diagram of a sample with a layered structure, the scattering of which may be measured by the scattering measurement system shown in FIG. 4A, according to an embodiment of the present disclosure;

FIG. 5B illustrates volumetric scattering from a volumetric scattering source of the sample shown in FIG. 5A, according to an embodiment of the present disclosure;

FIG. 5C illustrates a simulated correlation profile for the volumetric scattering shown in FIG. 5B, according to an embodiment of the present disclosure;

FIG. 5D illustrates surface scattering from a surface scattering source of the sample shown in FIG. 5A, according to an embodiment of the present disclosure;

FIG. 5E illustrates a simulated correlation profile for the surface scattering shown in FIG. 5D, according to an embodiment of the present disclosure;

FIG. 5F illustrates overall scattering of the sample shown in FIG. 5A, according to an embodiment of the present disclosure;

FIG. 5G illustrates an overall correlation profile for the overall scattering shown in FIG. 5F, according to an embodiment of the present disclosure;

FIG. 6A illustrates a schematic diagram of an optical component with a layered structure, the scattering of which may be measured by the scattering measurement system shown in FIG. 4A, according to an embodiment of the present disclosure;

FIG. 6B illustrates an image of a speckle pattern generated by an image sensor included in the scattering measurement system shown in FIG. 4A, according to an embodiment of the present disclosure;

FIG. 6C illustrates a correlation profile of the optical component shown in FIG. 6A, according to an embodiment of the present disclosure;

FIG. 6D illustrates a light intensity image of a selected cross section of the optical component obtained by a light-sheet microscope, according to an embodiment of the present disclosure;

FIG. 7 is a flowchart illustrating a method for measuring an overall scattering of an optical element and determining respective weights of volumetric scattering and surface scattering in the measured overall scattering of the optical element, according to an embodiment of the present disclosure;

FIG. 8A schematically illustrates a three-dimensional (“3D”) view of an optical film that may be included in an optical component with a layered structure, according to an embodiment of the present disclosure;

FIGS. 8B-8D schematically illustrate various views of a portion of the optical film shown in FIG. 8A, showing in-plane orientations of optically anisotropic molecules in the optical film, according to various embodiments of the present disclosure;

FIGS. 8E-8H schematically illustrate various views of a portion of the optical film shown in FIG. 8A, showing out-of-plane orientations of optically anisotropic molecules in the optical film, according to various embodiments of the present disclosure;

FIGS. 9A-9C schematically illustrate processes for fabricating an optical component with a layered structure, according to an embodiment of the present disclosure; and

FIGS. 10A and 10B schematically illustrate processes for fabricating an optical component with a layered structure, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction. The film plane may be a plane in the volume of the film, layer, coating, or plate, or may be a surface plane of the film, layer, coating, or plate. The term “in-plane” as in, e.g., “in-plane orientation,” “in-plane direction,” “in-plane pitch,” etc., means that the orientation, direction, or pitch is within the film plane. The term “out-of-plane” as in, e.g., “out-of-plane direction,” “out-of-plane orientation,” or “out-of-plane pitch” etc., means that the orientation, direction, or pitch is not within a film plane (i.e., non-parallel with a film plane). For example, the direction, orientation, or pitch may be along a line that is perpendicular to a film plane, or that forms an acute or obtuse angle with respect to the film plane. For example, an “in-plane” direction or orientation may refer to a direction or orientation within a surface plane, an “out-of-plane” direction or orientation may refer to a thickness direction or orientation non-parallel with (e.g., perpendicular to) the surface plane.

The term “orthogonal” as used in “orthogonal polarizations” or the term “orthogonally” as used in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, block or the like that describes processing of a light means that a major portion, including all, of a light is transmitted, reflected, diffracted, or blocked, etc. The major portion may be a predetermined percentage (greater than 50%) of the entire light, such as 100%, 98%, 90%, 85%, 80%, etc., which may be determined based on specific application needs.

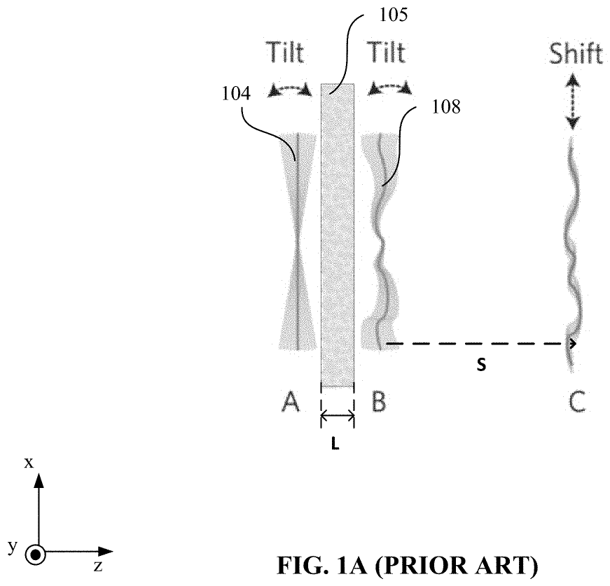

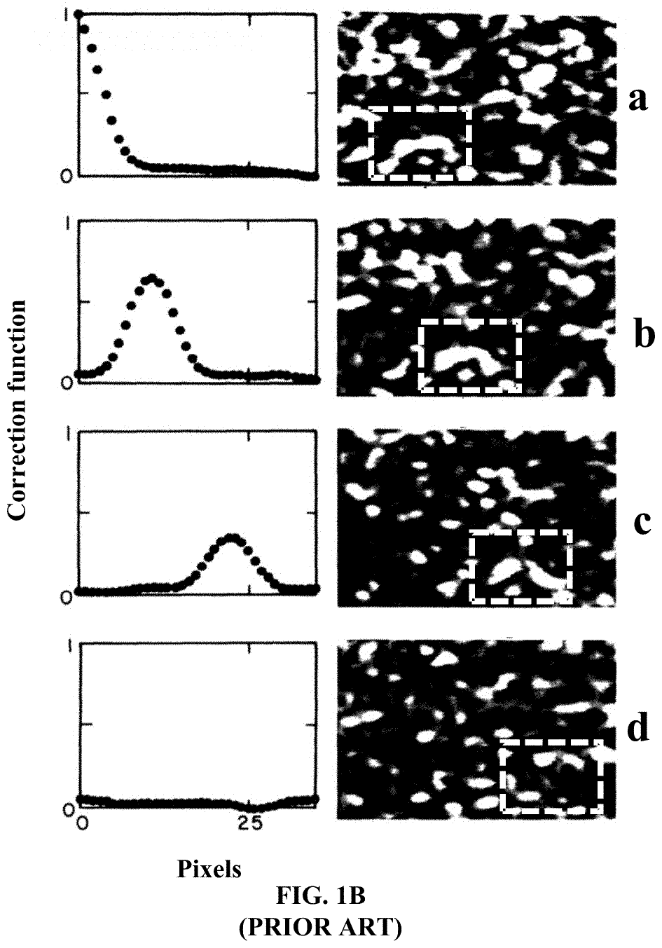

The present disclosure provides a system and a method for measuring an overall scattering of an optical component, and determining respective weights of volumetric scattering and surface scattering in the measured overall scattering based on a phenomenon known as optical memory effect. FIGS. 1A and 1B illustrate schematic diagrams showing the phenomenon known as the optical memory effect. As shown in FIG. 1A, a scattering medium 105 may scatter an input wavefront (e.g., a planar wavefront) 104 at an input plane of the scattering medium 105 (e.g., at plane A) as a scattered wavefront 108 at an output plane of the scattering medium 105 (e.g., at plane B). When the input wavefront 104 at the plane A is tilted within a certain angular range, the scattered wavefront 108 at the plane B may be equally tilted, resulting in a translation of a far-field intensity speckle pattern (that is a far-field scattering speckle pattern or far-field speckle pattern) at a distance s behind the scattering medium 105. The far-field intensity speckle pattern may be projected onto a screen (e.g., at plane C) having the distance s behind the scattering medium 105.

FIG. 1B shows four images of a small portion of a far-field speckle pattern projected onto the screen (e.g., at plane C) as the input wavefront 104 at the plane A is gradually tilted. A dashed square in each image encloses a large bright spot, which serves as a visual reference for tracking the motion of the speckle pattern. A reference speckle pattern shown in the image (a) is produced by an input laser beam that is normally incident onto the scattering medium 105, with the input wavefront 104 being parallel to the plane A. A first shifted speckle pattern shown in the image (b) is produced by the input laser beam when the propagation direction is rotated by 0.01° and the input wavefront 104 is rotated by 0.01°. A second shifted speckle pattern shown in the image (c) is produced by the input laser beam when the propagation direction is rotated by 0.02° and the input wavefront 104 is rotated by 0.02°. A third shifted speckle pattern shown in the image (d) is produced by the input laser beam when the propagation direction is rotated by 0.03° and the input wavefront 104 is rotated by 0.03°.

The correlation function shown to the left of image (a) corresponds to the cross-correlation coefficients between the reference speckle pattern (shown in the image (a)) and itself (which can be treated as a shifted speckle pattern with a shift being zero). That is, the correlation function shown to the left of image (a) is the autocorrelation function. Thus, the maximum correlation coefficient is 1. The correlation function shown to the left of each of images (b), (c), and (d) corresponds to the cross-correlation coefficients of the reference speckle pattern (shown in the image (a)) with the corresponding shifted speckle pattern shown in image (b), (c), or (d). The correlation coefficient is plotted as a function of the pattern shift in pixels, and the maximum (or the peak value) of the correlation function represents the maximum degree of correlation (e.g., overlap) between the reference speckle pattern (shown in the image (a)) and the corresponding shifted speckle pattern.

In the images (b) and (c), as the input laser beam is rotated around the sample by a small angle, the speckle patterns slowly change as the incidence angle of the input laser beam changes. The correlation function shown to the left of the image (b) or the image (c) tracks this motion, with the maximum correlation coefficient of the correlation function (or the peak value) decreases as the correlation becomes weaker. The shifted speckle pattern shown in image (d) is unrelated to the reference speckle pattern shown in image (a), and the correlation function shown to the left of the image (d) shows small statistical fluctuations around zero. The correlation function tracks the speckle patterns which, in turn, “remembers” and tracks the propagation direction or the incidence angle of the input laser beam onto the scattering medium 105.

Referring to FIGS. 1A and 1B, the translation or field-of-view (“FOV”) within which the optical memory effect holds (e.g., within which the maximum correlation coefficient changes from about 1 to about 0 as shown in the images (a) to (d) in FIG. 1B) may be approximated by the equation: FOV=s*λ/(π*L) (unit: radian or rad), where λ is an incident wavelength, L is the thickness of a scattering layer (e.g., the scattering medium 105 shown in FIG. 1A may include one or more scattering layers), and s is the distance between the scattering layer and the screen (e.g., at plane C). The translation or FOV within which the optical memory effect holds is referred to as a “memory effect range,” which is inversely proportional to the thickness L of the scattering layer, and directly proportional to the distance s of the scattering layer from the screen and the incidence wavelength λ.

When the distance s of the scattering layer from the screen is fixed, the memory effect range may be directly proportional to the value of (λ/L). When the incidence wavelength λ is fixed, as the thickness L of the scattering layer decreases, the memory effect range may increase. Thus, a thinner scattering layer (e.g., surface scattering layer) may have a much greater memory effect range than a thicker scattering layer (e.g., a volumetric scattering layer). The thickness of a surface scattering layer is often at the same scale as the incidence wavelength λ (e.g., hundreds of nanometers), while the thickness of a volumetric scattering layer is often much greater than the incidence wavelength λ (e.g., several micrometers to several tens of micrometers). Thus, the memory effect range of the surface scattering layer having a thickness of 500 nm may be about 100 times of the memory effect range of the volumetric scattering layer having a thickness of 50 μm. For example, the memory effect range of a volumetric scattering layer having the thickness of 50 μm may be about 0.01 rad (or about 0.57 degree), while the memory effect range of a surface scattering layer having the thickness of 500 nm may be about 1 rad (or about 57 degrees).

When the scattering medium 105 includes multiple scattering sources with different thicknesses (e.g., a surface scattering source and a volumetric scattering source), there may be multiple different memory effect ranges. Through determining the multiple memory effect ranges, the scattering contributions of the surface scattering and the volumetric scattering may be separately identified. For example, the scattering contributions from the volumetric scattering within a relatively thick scattering layer and the surface scattering within a relatively thin scattering layer may be separately identified.

Based on the optical memory effect, the present discourse provides a system and a method for measuring an overall scattering of an optical component, and determining the relative contributions of the volumetric scattering and the surface scattering in the measured overall scattering of the optical component. The determined relative contributions of the volumetric scattering and the surface scattering in the measured overall scattering may provide guidance for improving manufacturing processes of the optical component. For example, if the surface scattering is identified as the dominant scattering in the measured overall scattering of the optical component, then improving the surface smoothness may reduce the overall scattering. Surface smoothness enhancement may include polishing the surface or applying other types of surface treatment to the optical component. If the volumetric scattering is identified as the dominant scattering in the measured overall scattering of the optical component, then adjusting the material formulation or composition to reduce the intrinsic material scattering may reduce the overall scattering.

The system and the method disclosed herein may be applied to an optical component (or optical element) that may include a single layer or a plurality of layers of films or plates stacked together (referred to as a layered structure). The optical component with the layered structure may include at least two layers of different materials and/or structures. For example, the optical component with the layered structure may include a substrate, one or more optical films disposed on the substrate, and a protecting film disposed on the optical films. In some embodiments, the optical component with the layered structure may include other elements, such as an alignment structure (or layer) disposed between the substrate and the optical film, a cover glass disposed on the protecting film, etc. The optical film may be configured with a predetermined optical function. For example, the optical film may function as a transmissive or reflective optical element, such as a grating, a lens or lens array, a prism, a polarizer, a compensation plate, or a phase retarder, etc.

In some embodiments, the optical element may include a birefringent medium. The optical element may also be referred to as a birefringent medium layer. In some embodiments, an optic axis of the birefringent medium layer may be configured with a spatially varying orientation in at least one in-plane direction of the optical film. In some embodiments, the optical element may include a photo-polymer layer. In some embodiments, the photo-polymer layer may be a liquid crystal polymer (“LCP”) layer that includes polymerized (or cross-linked) liquid crystals (“LCs”), polymer-stabilized LCs, a photo-sensitive LC polymer, or any combination thereof. The LCs may include nematic LCs, twist-bend LCs, chiral nematic LCs, smectic LCs, or any combination thereof. In some embodiments, the photo-polymer layer may include a birefringent photo-refractive holographic material other than LCs, such as an amorphous polymer. In some embodiments, the optical element may function as a Pancharatnam-Berry phase (“PBP”), a polarization volume hologram (“PVH”) element, or a volumetric Bragg grating element. The optical element may be implemented in systems or devices for beam steering, display, imaging, sensing, communication, biomedical applications, etc. In some embodiments, the optical element may include a photosensitive material that provides a refractive index modulation based on an exposure light pattern. In some embodiments, the photo-polymer layer may be configured with a refractive index modulation in the photo-polymer layer. Hence, the photo-polymer layer may be referred to as a photosensitive index modulation polymer.

For example, the optical element may function as a beam steering device, which may be implemented in various systems for augmented reality (“AR”), virtual reality (“VR”), and/or mixed reality (“MR”) applications, e.g., near-eye displays (“NEDs”), head-up displays (“HUDs”), head-mounted displays (“HMDs”), smart phones, laptops, televisions, vehicles, etc. For example, the beam steering devices may be implemented in displays and optical modules to enable pupil steered AR, VR, and/or MR display systems, such as holographic near eye displays, retinal projection eyewear, and wedged waveguide displays. Pupil steered AR, VR, and/or MR display systems have features such as compactness, large field of views (“FOVs”), high system efficiencies, and small eye-boxes. The beam steering device may be implemented in the pupil steered AR, VR, and/or MR display systems to enlarge the eye-box spatially and/or temporally. In some embodiments, the beam steering device may be implemented in AR, VR, and/or MR sensing modules to detect objects in a wide angular range to enable other functions. In some embodiments, the beam steering device may be implemented in AR, VR, and/or MR sensing modules to extend the FOV (or detecting range) of the sensors in space constrained optical systems, increase detecting resolution or accuracy of the sensors, and/or reduce the signal processing time. In some embodiments, the beam steering device may be used in Light Detection and Ranging (“Lidar”) systems in autonomous vehicles. In some embodiments, the beam steering device may be used in optical communications, e.g., to provide fast speeds (e.g., speeds at the level of Gigabyte/second) and long ranges (e.g., ranges at kilometer levels). In some embodiments, the beam steering device may be implemented in microwave communications, 3D imaging and sensing (e.g., Lidar), lithography, and 3D printing, etc.

In some embodiments, the optical element may function as an imaging device, which may be implemented in various systems for AR, VR, and/or MR applications, enabling light-weight and ergonomic designs for AR, VR, and/or MR devices. For example, the imaging device may be implemented in displays and optical modules to enable smart glasses for AR, VR, and/or MR applications, compact illumination optics for projectors, light-field displays. In some embodiments, the imaging device may replace conventional objective lenses having a high numerical aperture in microscopes. In some embodiments, the imaging device may be implemented into light source assemblies to provide a polarized structured illumination to a sample, for identifying various features of the sample. In some embodiments, the imaging device may enable polarization patterned illumination systems that add a new degree for sample analysis.

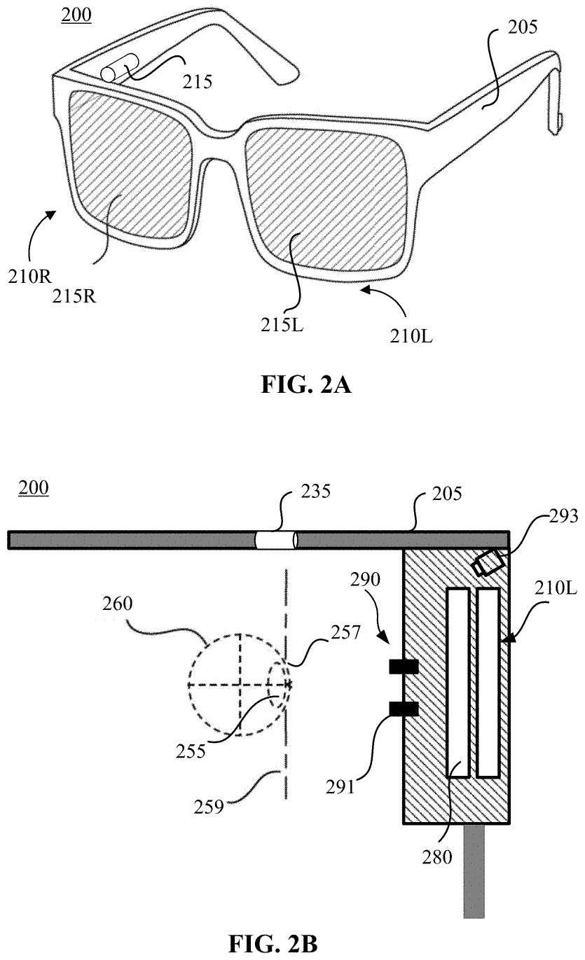

Some exemplary applications in AR, VR, or MR fields or some combinations thereof will be explained below. FIG. 2A illustrates a schematic diagram of a near-eye display (“NED”) 200 according to an embodiment of the disclosure. FIG. 2B is a cross-sectional view of half of the NED 200 shown in FIG. 2A according to an embodiment of the disclosure. For illustrative purposes, FIG. 2B shows the cross-sectional view associated with a left-eye display system 210L. The NED 200 may include a controller (not shown). The NED 200 may include a frame 205 configured to mount to a user's head. The frame 205 is merely an example structure to which various components of the NED 200 may be mounted. Other suitable type of fixtures may be used in place of or in combination with the frame 205. In some embodiments, the frame 205 may represent a frame of eyeglasses. The NED 200 may include right-eye and left-eye display systems 210R and 210L mounted to the frame 205. The NED 200 may function as a VR device, an AR device, an MR device, or any combination thereof. In some embodiments, when the NED 200 functions as an AR or an MR device, the right-eye and left-eye display systems 210R and 210L may be entirely or partially transparent from the perspective of the user, which may provide the user with a view of a surrounding real-world environment. In some embodiments, when the NED 200 functions as a VR device, the right-eye and left-eye display systems 210R and 210L may be opaque to block the light from the real-world environment, such that the user may be immersed in the VR imagery based on computer-generated images.

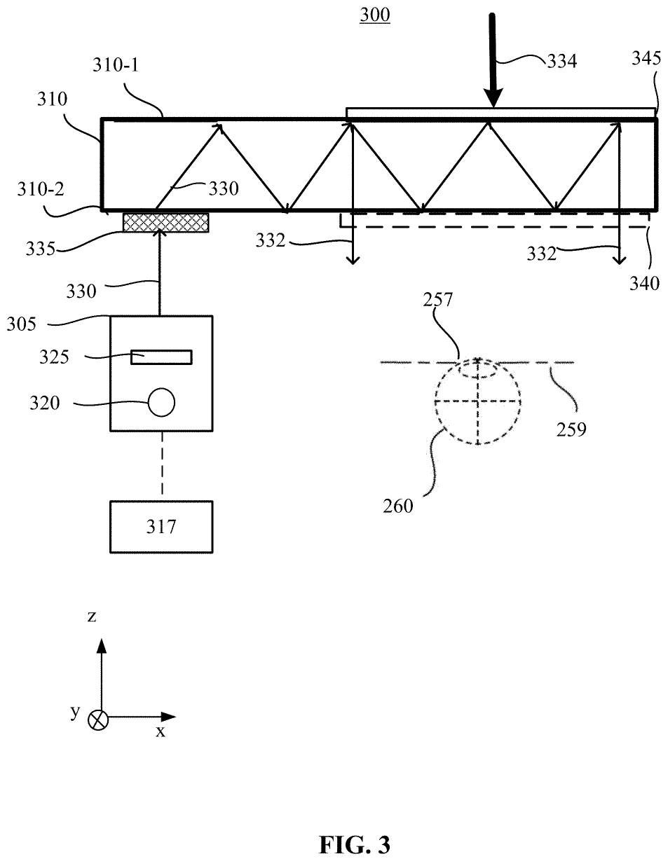

The right-eye and left-eye display systems 210R and 210L may include image display components configured to generate computer-generated virtual images, and direct the virtual images into left and right display windows 215L and 215R in a field of view (“FOV”). For illustrative purposes, FIG. 2A shows that the left-eye display systems 210L may include a light source assembly (e.g., a projector) 235 coupled to the frame 205 and configured to generate an image light representing a virtual image. Although the light source assembly 235 is shown as being mounted to the frame 205, the light source assembly 235 may be disposed at any suitable location of the NED 200. The right-eye and left-eye display systems 210R and 210L may be any suitable display systems. In some embodiments, the right-eye and left-eye display systems 210R and 210L may include one or more optical components with a layered structure (e.g., including a substrate, one or more optical films, and a protecting film, etc.). In some embodiments, the right-eye and left-eye display systems 210R and 210L may include a light guide display system. An example of a light guide display system will be explained in FIG. 3.

As shown in FIG. 2B, the NED 200 may also include a viewing optics system 280 and an object tracking system 290 (e.g., eye tracking system and/or face tracking system). The viewing optics system 280 may be configured to guide the image light output from the left-eye display system 210L to an exit pupil 257. The exit pupil 257 may be a location in an eye-box region 259 of the left-eye display system 210L where an eye pupil 255 of an eye 260 of a user may be positioned. For example, the viewing optics system 280 may include one or more optical elements configured to, e.g., correct aberrations in an image light output from the left-eye display systems 210L, adjusting a focus of an image light output from the left-eye display systems 210L, or perform another type of optical adjustment of an image light output from the left-eye display systems 210L. In some embodiments, the viewing optics system 280 may include one or more optical components with a layered structure (e.g., including a substrate, one or more optical films, and a protecting film, etc.). In some embodiments, the viewing optics system 280 may be omitted.

The object tracking system 290 may include an IR light source 291 configured to illuminate the eye 260 and/or the face, and an optical sensor 293 (e.g., a camera) configured to receive the IR light reflected by the eye 260 and generate a tracking signal relating to the eye 260 (e.g., an image of the eye 260). In some embodiments, the object tracking system 290 may also include an IR deflecting element (not shown) configured to deflect the IR light reflected by the eye 260 toward the optical sensor 293. In some embodiments, the object tracking system 290 may include one or more optical components with a layered structure (e.g., including a substrate, one or more optical films, and a protecting film, etc.). In some embodiments, the NED 200 may include an adaptive dimming element which may dynamically adjust the transmittance of lights reflected by real-world objects, thereby switching the NED 200 between a VR device and an AR device or between a VR device and an MR device. In some embodiments, along with switching between the AR/MR device and the VR device, the adaptive dimming element may be used in the AR and/MR device to mitigate differences in brightness of lights reflected by real-world objects and virtual image lights.

FIG. 3 illustrates an x-z sectional view of a light guide display system 300, according to an embodiment of the present disclosure. The light guide display system 300 may be a part of a system (e.g., an NED, an HUD, an HMD, a smart phone, a laptop, or a television, etc.) for VR, AR, and/or MR applications. For example, the light guide display system 300 may be included in the left-eye display system 210L shown in FIG. 2B. As shown in FIG. 3, the light guide display system 300 may include a light source assembly 305, a light guide 310 coupled with an in-coupling element 335 and an out-coupling element 345, and a controller 317. The light source assembly 305 may output an image light 330 representing a virtual image, and the light guide 310 coupled with the in-coupling element 335 and the out-coupling element 345 may guide the image light 330 toward a plurality of exit pupils 257 positioned in an eye-box region 259 of the system 300.

The light source assembly 305 may include a light source 320 and an light conditioning system 325. In some embodiments, the light source 320 may be configured to generate a coherent or partially coherent light. The light source 320 may include, e.g., a laser diode, a vertical cavity surface emitting laser, a light emitting diode, or a combination thereof. In some embodiments, the light source 320 may be a display panel, such as a liquid crystal display (“LCD”) panel, a liquid-crystal-on-silicon (“LCoS”) display panel, an organic light-emitting diode (“OLED”) display panel, a micro light-emitting diode (“micro-LED”) display panel, a digital light processing (“DLP”) display panel, a laser scanning display panel, or a combination thereof. In some embodiments, the light source 320 may be a self-emissive panel, such as an OLED display panel or a micro-LED display panel. In some embodiments, the light source 320 may be a display panel that is illuminated by an external source, such as an LCD panel, an LCoS display panel, or a DLP display panel. Examples of an external source may include a laser, an LED, an OLED, or a combination thereof. The light conditioning system 325 may include one or more optical components configured to condition the image light output from the light source 320, e.g., a collimating lens configured to transform or convert a linear distribution of the pixels in the display panel into an angular distribution of the pixels at the input side of the light guide 310.

The light guide 310 may receive the image light 330 at the in-coupling element 335 located at the first portion of the light guide 310. In some embodiments, the in-coupling element 335 may couple the image light 330 into a total internal reflection (“TIR”) path inside the light guide 310. The image light 330 may propagate inside the light guide 310 via TIR toward an out-coupling element 345 located at a second portion of the light guide 310. The out-coupling element 345 may be configured to couple the image light 330 out of the light guide 310 as a plurality of output lights 332 propagating toward the eye-box region 259. Each of the plurality of the output lights 332 may present substantially the same image content as the image light 330. Thus, the out-coupling element 345 may be configured to replicate the image light 330 received from the light source assembly 305 at an output side of the light guide 310 to expand an effective pupil of the light guide display system 300, e.g. in an x-axis direction shown in FIG. 3.

The light guide 310 may include a first surface or side 310-1 facing the real-world environment and an opposing second surface or side 310-2 facing the eye-box region 259. Each of the in-coupling element 335 and the out-coupling element 345 may be disposed at the first surface 310-1 or the second surface 310-2 of the light guide 310. In some embodiments, as shown in FIG. 3, the in-coupling element 335 may be disposed at the second surface 310-2 of the light guide 310, and the out-coupling element 345 may be disposed at the first surface 310-1 of the light guide 310. In some embodiments, the in-coupling element 335 may be disposed at the first surface 310-1 of the light guide 310. In some embodiments, the out-coupling element 345 may be disposed at the second surface 310-2 of the light guide 310. In some embodiments, both of the in-coupling element 335 and the out-coupling element 345 may be disposed at the same surface, such as the first surface 310-1 or the second surface 310-2 of the light guide 310. In some embodiments, the in-coupling element 335 or the out-coupling element 345 may be integrally formed (e.g., at least partially embedded) as a part of the light guide 310 at the corresponding surface. In some embodiments, the in-coupling element 335 or the out-coupling element 345 may be separately formed, and may be disposed at (e.g., affixed to) the corresponding surface.

In some embodiments, each of the in-coupling element 335 and the out-coupling element 345 may have a designed operating wavelength band that includes at least a portion of the visible wavelength band. In some embodiments, the designed operating wavelength band of each of the in-coupling element 335 and the out-coupling element 345 may not include the IR wavelength band. For example, each of the in-coupling element 335 and the out-coupling element 345 may be configured to deflect a visible light, and transmit an IR light without deflection or with negligible deflection.

In some embodiments, each of the in-coupling element 335 and the out-coupling element 345 may include one or more diffraction gratings, one or more cascaded reflectors, one or more prismatic surface elements, and/or an array of holographic reflectors, or any combination thereof. In some embodiments, each of the in-coupling element 335 and the out-coupling element 345 may include one or more diffractive structures, e.g., diffraction gratings. The diffraction grating may include a surface relief grating, a volume hologram grating, or a polarization hologram grating, etc. For discussion purposes, the in-coupling element 335 and the out-coupling element 345 may also be referred to as the in-coupling grating 335 and the out-coupling grating 345, respectively. In some embodiments, a period of the in-coupling grating 335 may be configured to enable TIR of the image light 330 within the light guide 310. In some embodiments, a period of the out-coupling grating 345 may be configured to couple the image light 330 propagating inside the light guide 310 through TIR out of the light guide 310 via diffraction.

The light guide 310 may include one or more materials configured to facilitate the total internal reflection of the image light 330. The light guide 310 may include, for example, a plastic, a glass, and/or polymers. The light guide 310 may have a relatively small form factor. The light guide 310 coupled with the in-coupling element 335 and the out-coupling element 345 may also function as an image combiner (e.g., AR or MR combiner). The light guide 310 may combine the image light 332 representing a virtual image and a light 334 from the real world environment (or a real world light 334), such that the virtual image may be superimposed with real-world images. With the light guide display system 300, the physical display and electronics may be moved to a side of a front body of the NED 200. A substantially fully unobstructed view of the real world environment may be achieved, which enhances the AR or MR user experience.

In some embodiments, the light guide 310 may include additional elements configured to redirect, fold, and/or expand the pupil of the light source assembly 305. For example, in some embodiments, the light guide display system 300 may include a redirecting element 340 coupled to the light guide 310, and configured to redirect the image light 330 to the out-coupling element 345, such that the image light 330 is coupled out of the light guide 310 via the out-coupling element 345. In some embodiments, the redirecting element 340 may be arranged at a location of the light guide 310 opposing the location of the out-coupling element 345. For example, in some embodiments, the redirecting element 340 may be integrally formed as a part of the light guide 310 at the corresponding surface. In some embodiments, the redirecting element 340 may be separately formed and disposed at (e.g., affixed to) the corresponding surface of the light guide 310.

In some embodiments, the redirecting element 340 and the out-coupling element 345 may have a similar structure. In some embodiments, the redirecting element 340 may include one or more diffraction gratings, one or more cascaded reflectors, one or more prismatic surface elements, and/or an array of holographic reflectors, or any combination thereof. In some embodiments, the redirecting element 340 may include one or more diffractive structures, e.g., diffraction gratings. The diffraction grating may include a surface relief grating, a volume hologram grating, a polarization hologram grating (e.g., a liquid crystal polarization hologram grating), or any combination thereof. For discussion purposes, the redirecting element 340 may also be referred to as the redirecting grating 340.

In some embodiments, the redirecting element 340 and the out-coupling element 345 may be configured to replicate the image light 330 received from the light source assembly 305 at the output side of the light guide 310 in two different directions, thereby providing a two-dimensional (“2D”) expansion of the effective pupil of the light guide display system 300. For example, the out-coupling element 345 may be configured to replicate the image light 330 received from the light source assembly 305 at the output side of the light guide 310 to expand the effective pupil of the light guide display system 300, e.g. in the x-axis direction shown in FIG. 3, and the redirecting element 340 may be configured to replicate the image light 330 received from the light source assembly 305 at the output side of the light guide 310 to expand the effective pupil of the light guide display system 300, e.g., in the y-axis direction shown in FIG. 3.

In some embodiments, one of the redirecting grating 340 and the out-coupling grating 345 may be disposed at the first surface 310-1 of the light guide 310, and the other one of the redirecting grating 340 and the out-coupling grating 345 may be disposed at the second surface 310-2 of the light guide 310. In some embodiments, the redirecting grating 340 and the out-coupling grating 345 may have different orientations of grating fringes (or grating vectors), thereby expanding the input image light 330 in two different directions. For example, the out-coupling grating 345 may expand the image light 330 along the x-axis direction, and the redirecting grating 340 may expand the image light 330 along the y-axis direction. The out-coupling grating 345 may further couple the expanded input image light out of the light guide 310. Accordingly, the light guide display system 300 may provide 2D pupil replication (or pupil expansion) at a light output side of the light guide display system 300. In some embodiments, the redirecting grating 340 and the out-coupling grating 345 may be disposed at the same surface of the light guide 310. In addition, to expand the exit pupil (or effective pupil) of the light guide display system 300 in more than two directions, more than two gratings (or layers of diffractive structures) may be disposed at the light output region of the light guide 310.

In some embodiments, multiple functions, e.g., redirecting, folding, and/or expanding the pupil of the light generated by the light source assembly 305 may be combined into a single element, e.g. the out-coupling element 345. For example, the out-coupling element 345 itself may be configured to provide a 2D expansion of the effective pupil of the light guide display system 300. For example, the out-coupling grating 345 may be a 2D grating including a single grating layer or a single layer of diffractive structure.

The light guide 310, the in-coupling grating 335, the out-coupling grating 345, and/or the redirecting grating 340 may be designed to be substantially transparent in the visible spectrum. The in-coupling grating 335, the out-coupling grating 345, and/or the redirecting grating 340 may be optical films functioning as gratings. For example, the in-coupling grating 335, the out-coupling grating 345, and/or the redirecting grating 340 may be a polymer layer, e.g., a photo-polymer film, or a liquid crystal polymer film, etc. In some embodiments, protecting films may be disposed at the in-coupling grating 335, the out-coupling grating 345, and/or the redirecting grating 340 for protection purposes. In some embodiments, the light guide 310 may also be coupled to one or more additional optical films that are substantially transparent in the visible spectrum. For example, the in-coupling grating 335, the out-coupling grating 345, and/or the redirecting grating 340 may be coupled to an additional optical film.

The light guide 310 disposed with the in-coupling grating 335, the out-coupling grating 345, and/or the redirecting grating 340 may be an example of an optical component with a layered structure disclosed in the present disclosure. Such an optical component with the layered structure may be substantially optically transparent at least in the visible wavelength range (e.g., about 380 nm to about 700 nm). The optical component with the layered structure may scatter a light when the light propagates through the layered structure of the optical component. When the light scattering is inelastic, for example, Raman scattering, the light scattering may provide information of the chemical (or material) composition of the multiple layers in the optical component. When the light scattering is elastic, the light scattering may disclose structure information of the multiple layers in the optical component at different spatial scales: much smaller than the wavelength of the light (Rayleigh scattering), comparable to the wavelength of the light (Mie scattering), or much larger than the wavelength of the light (Geometric scattering). Some elastic scattering behaviors may cause haze, which is a measurement of clarity or the “see through quality” of the optical component with the layered structure based on a reduction of sharpness. Thus, it is highly desirable to measure the light scattering of the optical component in relevant spectral ranges, ensuring that the haze of the optical component is within a predetermined range, and the optical component meets design specifications and customer expectations.

It may be desirable to identify and/or visualize the sources of scattering in the optical component, e.g., whether the scattering is from a volume of the optical component (i.e., volumetric scattering), or from a surface of the optical component (i.e., surface scattering at an interface between two neighboring layers, and/or at an interface between a layer and an outside environment (e.g., air)). Moreover, it may be desirable to identify the relative scattering contributions from the volumetric scattering and the surface scattering in the overall measured scattering. The identification and/or visualization of the scattering may provide guidance for the design (e.g., structures, materials, compositions, etc.) and the fabrication (e.g., manufacturing process improvements) of an optical component with reduced scattering. For example, when the surface scattering is identified as the dominant scattering, then polishing or other types of surface treatments of the optical component may reduce the overall scattering. When the volumetric scattering is identified as the dominant scattering, then adjusting the material formulation to reduce the intrinsic material scattering may reduce the overall scattering. The disclosed system and method for measuring the overall scattering and identifying the relative contributions of the surface and volumetric scattering in the overall scattering may be low-cost, highly sensitive, and highly efficient, and may be used in quality control process of mass production of the optical components.

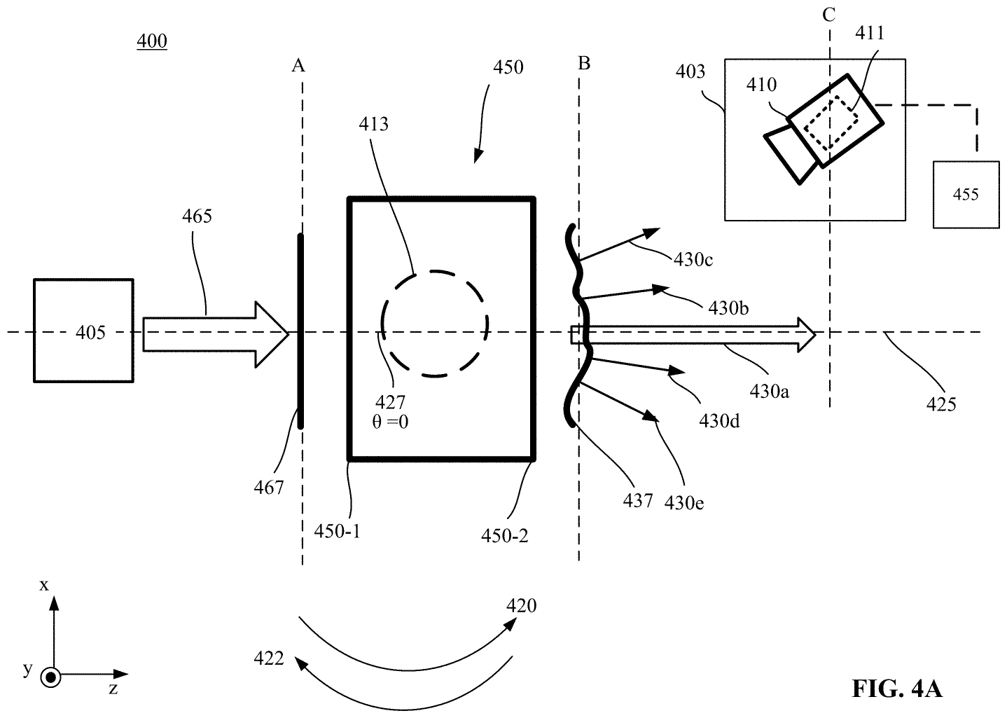

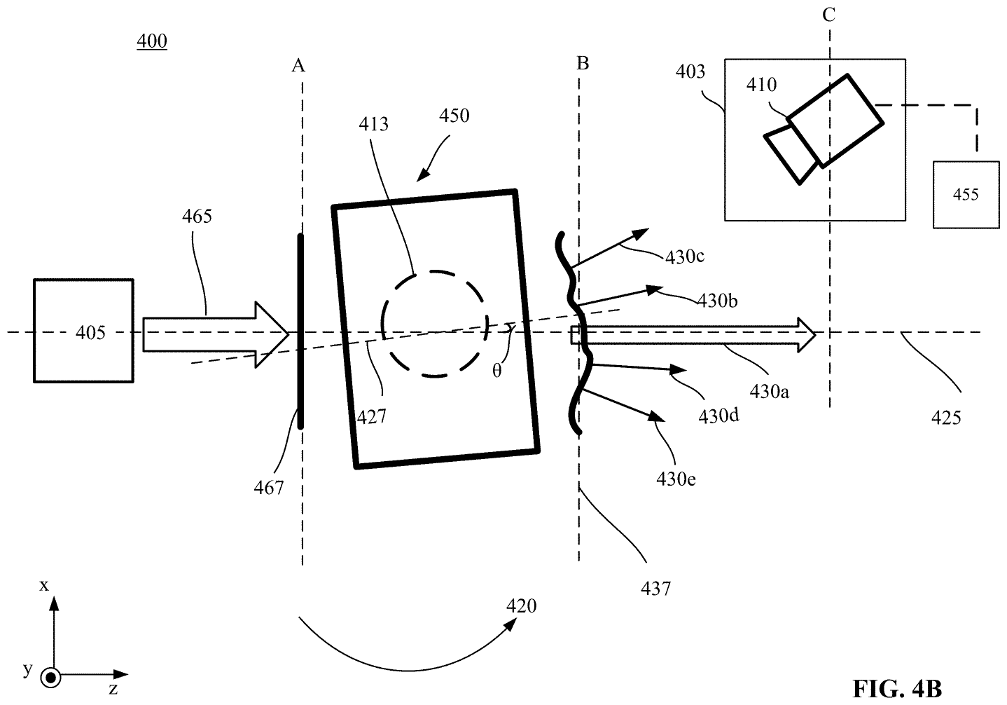

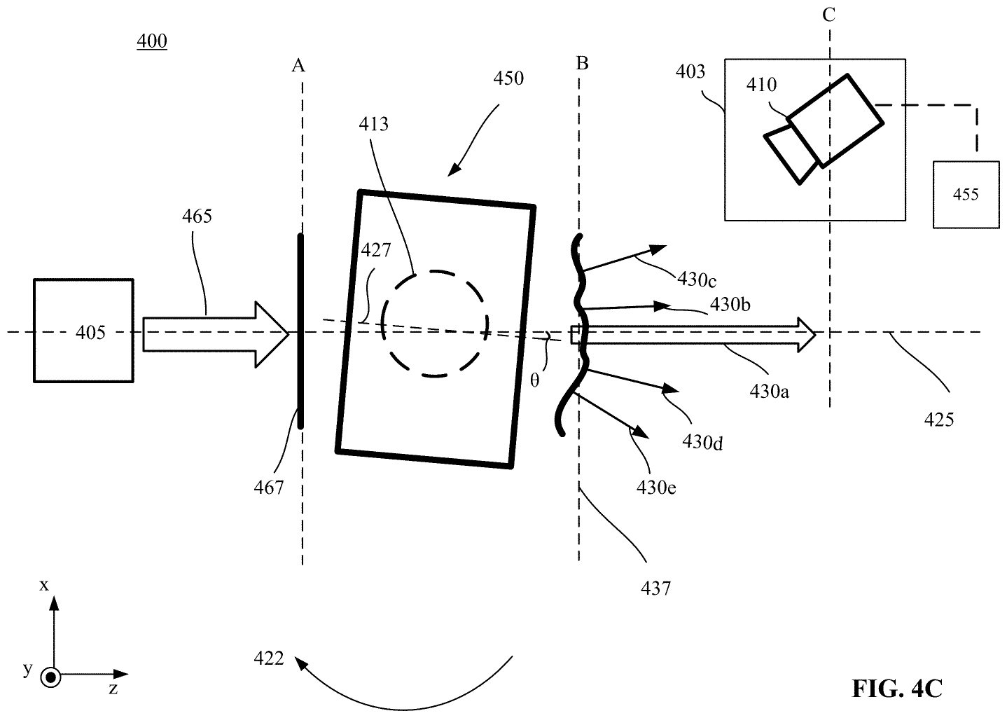

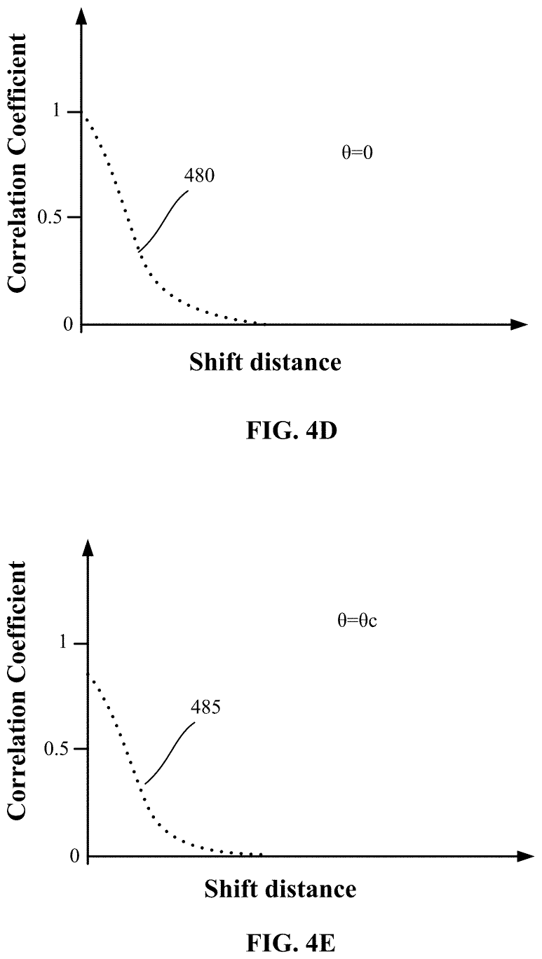

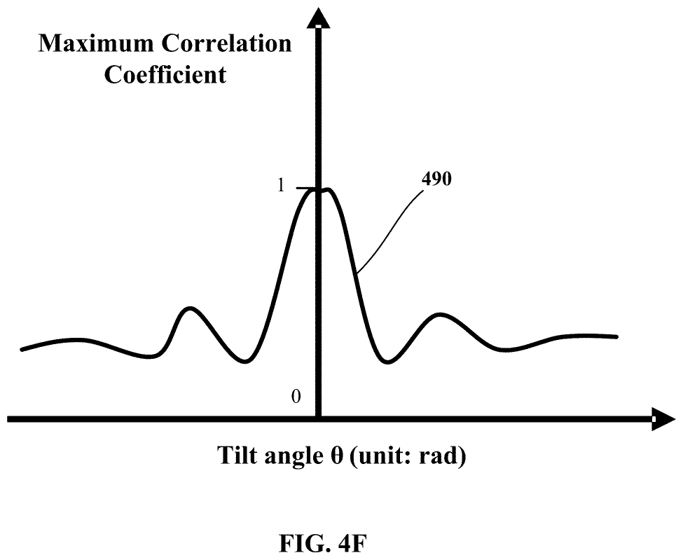

FIG. 4A schematically illustrates a system 400 for measuring an overall scattering of an optical component and determining separate contributions of volumetric scattering and surface scattering in the measured overall scattering of the optical component, according to an embodiment of the present disclosure. The view shown in FIG. 4A may be a schematic top view of the system 400. As shown in FIG. 4A, the system 400 may include a light source 405, a detection assembly 403, and a controller 455. A sample 450 may be mounted on a rotating structure 413 (e.g., a rotating stage, platform, arm, etc.), and may be located between the light source 405 and the detection assembly 403. The sample 450 may be a single-layer optical component or a multi-layer optical component (e.g., an optical component with a layered structure). The light source 405 may be configured to emit a probing beam 465 configured to illuminate the sample 450 for the purpose of scattering measurement. The probing beam 465 may have a predetermined wavelength range (e.g., a wavelength range within the visible spectrum for measuring the visible light scattering of the sample 450). In some embodiments, the light source 405 may be a laser light source configured to emit a laser beam, such as a laser diode. In some embodiments, the laser beam may be a green laser beam with a center wavelength of about 532 nm. In some embodiments, the probing beam 465 may be a collimated laser beam with a planar wavefront (also referred to as 465 for discussion purposes), propagating along an optical axis 425 of the system 400. In some embodiments, the position of the light source 405 may be fixed with respect to the optical axis 425 of the system 400. In some embodiments, the light source 405 may include a single laser light source associated with a single laser wavelength. In some embodiments, the light source 405 may include a plurality of laser light sources associated with multiple different laser wavelengths, and the system 400 may be used to measure light scattering of the sample 450, and separating the contributions of the volumetric scattering and surface scattering in the measured overall scattering of the sample 450 at different laser wavelengths.

The sample 450 may include a light input surface 450-1 and a light output surface 450-2 located at opposite sides of the sample 450. In some embodiments, the light input surface 450-1 and the light output surface 450-2 may be parallel with one another. In some embodiments, the sample 450 may have at least one curved surface, and the light input surface 450-1 may be unparallel with the light output surface 450-2. The light input surface 450-1 may receive the probing beam 465 output from the light source 405. The probing beam 465 may propagate through the sample 450, and exit the sample 450 at the light output surface 450-2 as a plurality of transmitted and scattered beams 430, e.g., including a directly transmitted beam 430a (also considered as a scattered beam with a scattering angle of 0°) and a plurality of scattered beams 430b-430e with non-zero scattering angles. The beams 430b-430e output from the light output surface 450-2 may be referred to as forwardly scattered beams, and the corresponding scattering may be referred to as forward scattering.

Accordingly, the sample 450 may scatter an input wavefront (e.g., a planar wavefront) 467 of the probing beam 465 at an input plane of the sample 450 (e.g., at plane A) as an overall scattered wavefront 437 at an output plane of the sample 450 (e.g., at plane B). The overall scattered wavefront 437 may propagate toward the detection assembly 403. In some embodiments, the positions of the plane A and the plane B may be fixed. In some embodiments, when the sample 450 includes both of surface scattering sources and volumetric scattering sources, the overall scattered wavefront 437 may be a result of the interference of multiple scattered wavefronts including, e.g., one or more scattered wavefronts generated by one or more surface scattering sources and one or more scattered wavefronts generated by one or more volumetric scattering sources. In other words, the overall scattered wavefront 437 may be a superposition of the multiple scattered wavefronts.

The detection assembly 403 may be configured to aim toward the light output surface 450-2 to receive one or more of the scattered beams 430b-430e output from the light output surface 450-2 (or a portion of the overall scattered wavefront 437). For example, the detection assembly 403 may be tilted with respect to the optical axis 425 of the system 400 to detect one or more of the scattered beams 430b-430e (e.g., may not detect the directly transmitted beam 430a). In some embodiments, the position of the detection assembly 403 may be fixed with respect to the optical axis 425 of the system 400. Here the position being fixed means that the orientation of the imaging device 410 with respect to the optical axis 425 (or with respect to the propagation direction of the probing beam 465, or with respect to the sample 450) is also fixed. The detection assembly 403 may include an imaging device 410, and a diaphragm (or an iris) (not shown) disposed in front of the imaging device 410. The diaphragm may define an aperture with a predetermined size (e.g., a predetermined circular hole), through which a beam can reach the imaging device 410. In other words, the diaphragm may define an area (or size of an aperture) through which the imaging device 410 can receive the beams. The diaphragm may also reduce the stray lights that may be received by the image sensor 411.

The imaging device 410 may include an image sensor 411. In some embodiments, the imaging device 410 may also include a lens or lens array (not shown) disposed in front of the image sensor 411. The lens (or lens array) may focus the beams onto the image sensor 411. In some embodiments, the imaging device 410 may be a camera, and the image sensor 411 may also be referred to as a camera sensor. The image sensor 411 may be any suitable 2D image sensor including a 2D array of pixels, such as a charge-coupled device (“CCD”) image sensor, a complementary metal-oxide-semiconductor (“CMOS”) image sensor, an N-type metal-oxide-semiconductor (“NMOS”) image sensor, a pixelated polarized image sensor, or any other image sensors.

The scattering of the sample 450 may generate a far-field intensity speckle pattern (that is a far-field speckle pattern) at a distance s behind the sample 450. The far-field intensity speckle pattern may be projected onto the image sensor 411 (e.g., onto a chip of the image sensor 411 that is disposed at a plane C at the distance s behind the sample 450). In some embodiments, the position of the plane C may be fixed. The image sensor 411 may record the speckle pattern, and generate an image of the speckle pattern. A speckle pattern is a fine granular pattern of light obtained by the scattering of a coherent light beam, and results from the interference of multiple scattered wavefronts (e.g., a surface scattered wavefront generated by the surface scattering and a scattered wavefront generated by the volumetric scattering). The speckle pattern may include multiple speckles or speckle spots. The diaphragm and the lens (or lens array) may also control the size of the speckle pattern.

During the scattering measurement of the sample 450, the controller 455 may control the rotation of the rotating structure 413 to cause the sample 450 to rotate from its initial position, thereby tilting a reference axis 427 (shown in FIG. 4B) affixed to the sample 450 with respect to a propagation direction of the probing beam 465 before the probing beam 465 is scattered by the sample 450 (or with respect to the optical axis 425) in at least one of a counter-clockwise direction 420 or a clockwise direction 422, within a predetermined tilting range. A tilt angle θ may be formed between the reference axis 427 of the sample 450 and the propagation direction of the probing beam 465 (or the optical axis 425). When the sample 450 is at the initial position, the reference axis 427 affixed to the sample 450 may pass through a center of rotation of the sample 450, and may be in the same direction as the propagation direction of the probing beam 465. The initial position of the sample 450 may be a position where the tilt angle θ of the sample 450 is 0°. The center of rotation of the sample 450 may be a fixed point around which the sample 450 is rotated to change the tilt angle θ within the predetermined tilting range. As the rotating structure 413 rotates, the sample 450 may be rotated from one angular position to another angular position, such that the tilt angle θ of the sample 450 may be changed from one tilt angle to another tilt angle. In some embodiments, the tilt angle θ may change in the predetermined tilting range at a predetermined increment, from one tilt angle to another tilt angle. The predetermined increment may be fixed (i.e., constant) or varying for different sub-ranges of the predetermined tilting range. It is noted that the reference axis 427 shown in FIG. 4A is an example reference axis. Other reference axes affixed to the sample 450 may be used to define the tilt angle.

The tilt angle θ of the sample 450 may be positive or negative. For example, a counter-clockwise direction 420 may be defined as a positive direction, and then a clockwise direction 422 may be defined as a negative direction. FIG. 4B shows that the sample 450 is rotated counter-clockwise, such that the reference axis 427 forms a positive tilt angle θ with respect to the propagation direction of the probing beam 465 (or with respect to the optical axis 425). FIG. 4C shows that the sample 450 is rotated clockwise, such that the reference axis 427 forms a negative tilt angle with respect to the propagation direction of the probing beam 465 (or the optical axis 425).

Referring to FIGS. 4A-4C, at each tilt angle as the sample 450 is rotated, the image sensor 411 may detect one or more of the scattered beams 430b-430e, and record a speckle pattern as speckle pattern image data. In some embodiments, to visualize the speckle pattern, the image sensor 411 may generate an image of the speckle pattern based on the speckle pattern image data. After the sample 450 is rotated at the predetermined increment throughout the predetermined tilting range, the image sensor 411 may have recorded a series of speckle patterns (or a plurality of sets of speckle pattern image data) associated with a series of tilt angles of the sample 450. In some embodiments, the image sensor 411 may generate a series of images of the speckle patterns based on the sets of speckle pattern image data.

Referring to FIG. 4A, when the sample 450 is at the initial position (i.e., the tilt angle θ of the sample 450 is 0°), an incidence angle of the probing beam 465 onto the light input surface 450-1 of the sample 450 may be 0°. When the sample 450 is at the initial position, the angular position of the sample 450 may be referred to as a reference angular position, the speckle pattern (as represented by the speckle pattern image data) recorded by the image sensor 411 may be referred to as a reference speckle pattern, and the image of the reference speckle pattern may be referred to as a reference image.

Referring to FIGS. 4B and 4C, as the sample 450 is rotated in the counter-clockwise direction or the clockwise direction to an angular position different from the reference angular position to change the tilt angle, the incidence angle of the probing beam 465 may vary (e.g., increase), and the input wavefront 467 at the plane A may be tilted with respect to the light input surface 450-1 of the sample 450. Due to the optical memory effect, the overall scattered wavefront 437 at the plane B may be tilted accordingly, resulting in a change in the far-field speckle pattern at the distance s behind the sample 450. Thus, the speckle pattern recorded by the image sensor 411 may be changed as compared to the reference speckle pattern, and the image of the speckle pattern generated by the by the image sensor 411 may be changed as compared to the reference image. In some embodiments, when the tilt angle of the sample 450 gradually increases, the tilt of the input wavefront 467 may gradually increase, and the degree of the change of the speckle pattern with respect to the reference speckle pattern may gradually increase. It is noted that in some embodiments, the image of the speckle pattern may be generated by the controller 455, rather than by the image sensor 411. For convenience of discussion and as an example, the image of the speckle pattern may be described herein as being generated by the image sensor 411.

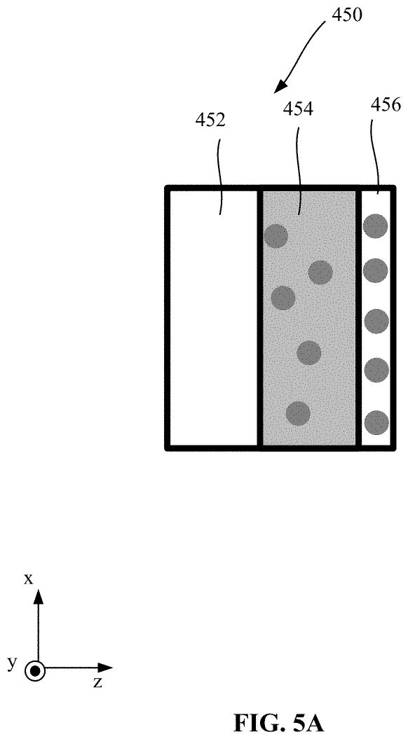

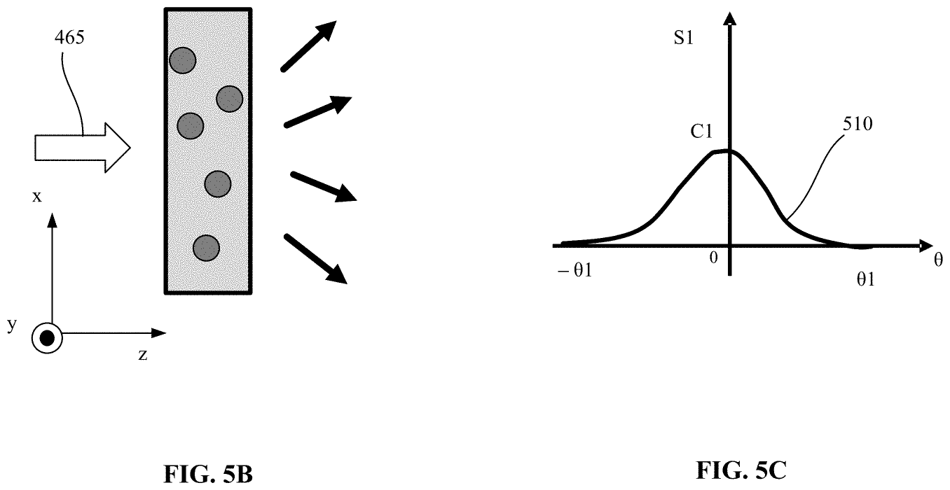

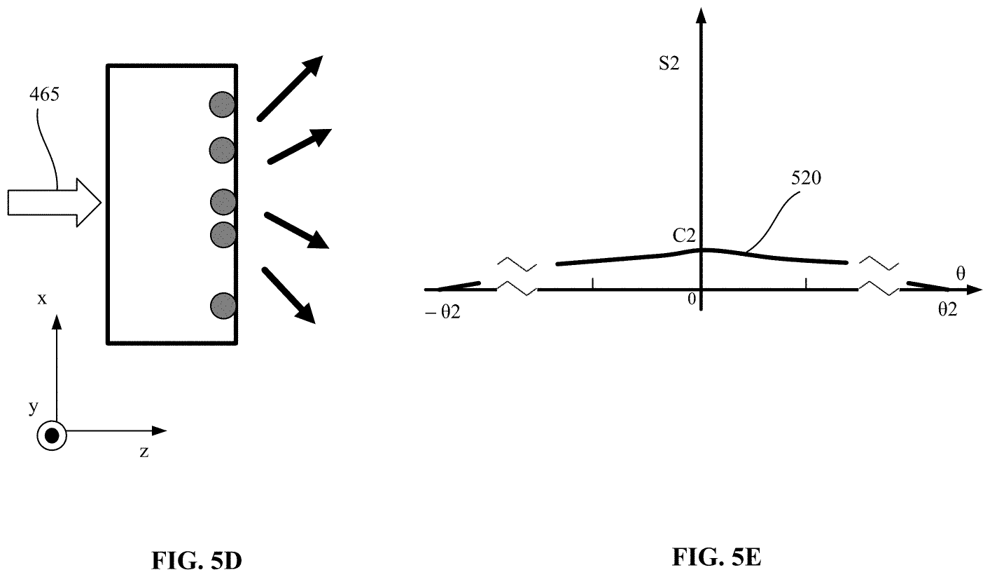

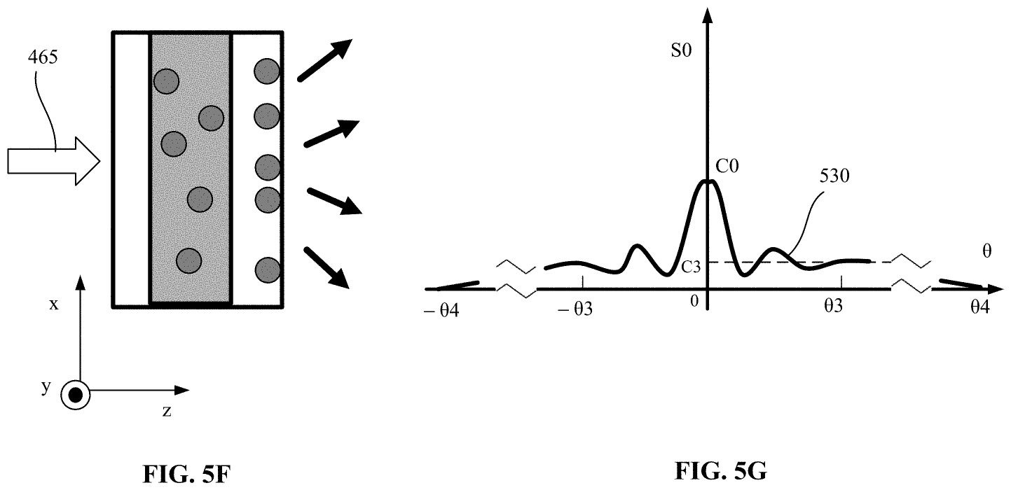

At each angular position (or at each tilt angle) as the sample 450 is tilted within the predetermined tilting range, the image sensor 411 may detect one of the scattered beams 430b-430e, and record a speckle pattern as speckle pattern image data. In some embodiments, the image sensor 411 may generate an image of the speckle pattern based on the recorded speckle pattern image data. In some embodiments, the image sensor 411 may transmit the recorded speckle pattern image data to the controller 455, and the controller 455 may generate the image of the speckle pattern. In some embodiments, the controller 455 may further process the sets of the speckle pattern image data via suitable data processing or image processing algorithms to determine or identify the relative contributions of the volumetric scattering and the surface scattering in the overall measured scattering of the sample 450. The details of processing of the recorded speckle patterns (or sets of speckle pattern image data) will be explained in connection with FIGS. 4D-5D.

Although the above descriptions use forward scattering as an example, a system similar to those shown in FIG. 4A may also be used for measuring backward scattering and identifying the relative contributions of the volumetric scattering and the surface scattering in the overall backward scattering of the sample 450, with some modification to the configuration. To measure the backward scattering, the image sensor 411 and the light source 405 may be disposed at the same side of the sample 450. The other descriptions relating to the forward scattering also apply to the backward scattering. The sample 450 may be rotated such that the optical axis 427 of the sample 450 may be tilted with respect to the probing beam 465 (or the optical axis 425). The tilt angle may be gradually increased (either in the counter-clockwise direction or the clockwise direction). At each angular position corresponding to a tilt angle, the image sensor 411 may detect one of the scattered beams 430b-430e, and capture scattering image data of the speckle patterns.

In the disclosed embodiments, the image sensor 411 may enhance the scattering measurement performance as compared to a single photodiode or a photodiode array used in conventional technology for measuring the light intensity of scattered beams. For example, the image sensor 411 may provide a wider dynamic measurement range as compared to the single photodiode and the photodiode array. In some embodiments, the exposure time of the image sensor 411 may range from about 1 μs (micro-second) to 10 s (second), providing 7 orders of magnitude of adjustments. In some embodiments, the image sensor 411 may provide 8-bit depth, corresponding to a range of 0 to 28 (=256), providing 2 orders of magnitude. The number of pixels can be about 10′, providing 7 orders of magnitude. In total, the image sensor 411 can support a 16-order of magnitude measurement dynamic range. In some embodiments, the image sensor 411 may provide 10-bit depth, 12-bit depth, or even higher depth, increasing the dynamic range of the image sensor 411. In addition, the image sensor 411 has advantages of high measurement sensitivity due to the higher light collection efficiency. The image sensor 411 may have an active light collection area of at least 2*2 cm², whereas a typical photodiode has an active light collection area of about 1*1 mm². Thus, the light collection area provided by the image sensor 411 is at least 400 times of that of a typical photodiode. This translates into an about 400 times of higher light collection efficiency.

In some embodiments, the processes for performing the scattering measurement using the system 400 shown in FIG. 4A may include a first step of exposure time pre-setting, a second step of dark frame characterization, and a third step of data acquisition, dark frame subtraction, and data processing. In some embodiments, these processes or steps may be performed automatically by the controller 455 and the various elements or components included in the system 400 that may be controlled by the controller 455. In some embodiments, one or more steps may be manually performed by an operator of the system 400.

As shown in FIGS. 4A-4C, the first step of exposure time pre-setting may be performed to pre-set the exposure time of the image sensor 411 for each angular position (or tilt angle) of the sample 450. In some embodiments, the controller 455 may control the tilt of the sample 450, and may determine the exposure times for the angular positions automatically based on pre-programmed methods for determining the exposure times. In some embodiments, the pre-set exposure times for different angular positions (or tilt angles) may be different. In some embodiments, at least two of the pre-set exposure times for the respective angular positions (or tilt angles) may be different, or at least two of the pre-set exposure times for the respective angular positions (or tilt angles) may be the same.

Various methods may be used to pre-set the exposure time for each angular position for the image sensor 411. In some embodiments, the histogram captured by the image sensor 411 at each angular position may be analyzed by the controller 455 using a suitable algorithm to determine an exposure time. In some embodiments, the exposure time may be determined according to a working range of the image sensor 411 within which usable light intensity data can be extracted, and the light intensity detected by the pixel (i.e., the pixel value) of the image sensor 411 (or the light intensity received by the image sensor 411). The working range of the image sensor 411 may be a range between a maximum intensity value and a minimum intensity value that can be acquired by the image sensor 411. When the light intensity detected by the pixel (i.e., the pixel value) of the image sensor 411 is at the maximum intensity value or higher (saturation), the pixel in the capture image may appear white, whereas when the light intensity detected by the pixel (i.e., the pixel value) of the image sensor 411 is at the minimum intensity value or lower, the pixel in the captures image may appear black. The light intensity detected by the pixel (i.e., the pixel value) of the image sensor 411 may be determined, in part, by the number of photons received by the pixel, the energy of a single photon, and the exposure time. In some embodiments, at an angular position of the sample 450, the exposure time may be set such that the light intensity detected by the pixels in the image sensor 411 may be limited to be within a predetermined smaller sub-range of the total working range of the image sensor 411 (referred to as a predetermined detection range). In other words, at an angular position of the sample 450, the exposure time may be set such that the pixel value of the image sensor 411 may be limited to be within a predetermined pixel value range. When a detected light intensity is within the predetermined detection range (or the pixel value is within the predetermined pixel value range), the image sensor 411 may provide a contrast ratio and a signal-to-noise ratio that are above predetermined thresholds. For example, a lower limit of the predetermined detection range may be greater than the minimum intensity value, and equal to or greater than a first percentage (e.g., 30%, 35%, 40%, or 45%, etc.) of the maximum intensity value. An upper limit of the predetermined smaller sub-range may be equal to or smaller than a second predetermined percentage (e.g., 70%, 65%, 60%, or 55%, etc.) of the maximum intensity value. The second percentage is greater than the first percentage.

After initial exposure times are determined, in some embodiments, the actual scattering measurement may be preliminarily performed to check for irregularities, i.e., whether any exposure time is too short or too long that may cause irregular or undesirable exposure in the image generated based on the received beams 430b-403e, or any irregular data in the captured image data. If any irregularity is detected in the generated image or captured image data, the processes of determining exposure times may be repeated to refine or adjust the exposure times, until a satisfactory set of exposure times are determined for the subsequent actual scattering measurement of the sample 450. In some embodiments, the processes of checking for irregularities may be omitted, and the initial exposure times may be directly used as the final exposure times. The first step of exposure time pre-setting may also be automated by the controller 455 based on predetermined algorithms or programs.

After the exposure times are determined and pre-set in the image sensor 411 for each angular position (or tilt angle) of the sample 450, the second step of dark frame characterization may be performed for removing the ambient light in the environment and intrinsic noise of the image sensor 411. Referring to FIGS. 4A-4C, to perform the step of dark frame characterization, the light source 405 may be shut down or turned off, such that the sample 450 is not illuminated by the probing beam 465. The sample 450 may be rotated to different tilt angles (corresponding to different angular positions), and the image sensor 411 may measure the dark frame light intensity at each angular position (or tilt angle) of the sample 450 using the corresponding exposure time determined in the first step.

The third step of data acquisition, dark frame subtraction, and data processing may be performed after the second step of dark frame characterization is performed. In the third step, an actual scattering measurement of the sample 450 may be performed. Still referring to FIGS. 4A-4C, the light source 405 may be turned on. The sample 450 may be rotated to different angular positions (or tilt angles), and the image sensor 411 may be exposed to the scattered beams passing through the diaphragm for the corresponding pre-set exposure time, may record a speckle pattern of the detected beams as a set of speckle pattern image data (or a first set of intensity data). The controller 455 may subtract the dark frame light intensity data (or a second set of intensity data) from the first set of intensity data. For example, the controller 455 may subtract respective pixel values of the second set of intensity data from the corresponding respective pixel values of the first set of intensity data to obtain a third set of intensity data. The controller 455 may further process the third set of intensity data according to a suitable algorithm to obtain a scattering light intensity at the corresponding angular position (or tilt angle). In some embodiments, the controller 455 may scale or normalize the scattering intensity at the angular position (or tilt angle) with the corresponding exposure time, and obtain a set of scattering intensities per time unit for the corresponding angular position (or tilt angle). The set of scattering intensity per time unit may be referred to as a fourth set of intensity data.

Thus, after the sample 450 is tilted at the predetermined increment throughout the predetermined tilting range (or a measurement angular range), a series of speckle patterns may be recorded as a plurality of sets of speckle pattern image data. In some embodiments, the image sensor 411 or the controller 455 may generate a series of images of speckle patterns based on the acquired speckle pattern image data. The controller 455 may process the plurality of sets of speckle pattern image data to obtain a plurality of sets of scattering intensities per time unit (or a plurality of fourth sets of intensity data) for respective tilt angles of the sample 450. The controller 455 may further process the plurality of fourth sets of intensity data to determine the relative contributions the volumetric scattering and the surface scattering in the overall measured scattering of the sample 450.

For example, the controller 455 may process each fourth set of intensity data to generate a correlation function via a suitable data or image processing algorithm. The correlation function may quantitatively indicate the degree of overlap of a corresponding speckle pattern with respect to the reference speckle pattern. In some embodiments, the correlation function may correspond to the cross-correlation coefficients of the reference speckle pattern with the corresponding speckle pattern. Based on the generated correlation function, the controller 455 may determine a maximum correlation coefficient (or a peak) of the correlation function. The maximum correlation coefficient of the correlation function may represent the maximum degree of correlation between the reference speckle pattern and the corresponding speckle pattern obtained at a specific tilt angle.

FIG. 4D illustrates a correlation function 480 of a first speckle pattern with respect to the reference speckle pattern, according to an embodiment of the present disclosure. As shown in FIG. 4D, the horizontal axis represents the shift of pixel, and the vertical axis represents the correlation coefficient. In FIG. 4D, the correlation coefficient may range between 0 and 1.0. The higher the correlation coefficient, the higher the correlation between the corresponding speckle pattern and the reference speckle pattern. For discussion purposes, the first speckle pattern is recorded when the tilt angle of the sample 450 is 0°, i.e., the first speckle pattern is the reference speckle pattern. Thus, the correlation function 480 is that of the reference speckle pattern with itself, and the correlation function 480 is an autocorrelation function. For discussion purposes, in FIG. 4D, the correlation function 480 is calculated in terms of the rightward shift distance (e.g., in pixels) of a replica of the first speckle pattern against the reference speckle pattern. The first speckle pattern (or the reference speckle pattern) and the replica of the first speckle pattern are fully correlatedly when the shift distance is zero, and the maximum correlation coefficient (or the peak) of the correlation function 480 is 1. As the shift distance increases, the correlation coefficient quickly decreases to zero.

FIG. 4E illustrates a correlation function 485 of a second speckle pattern with respect to the reference speckle pattern, when the tilt angle of the sample 450 is non-zero, i.e., θ=θc, where θc is non-zero, according to an embodiment of the present disclosure. As shown in FIG. 4E, the horizontal axis represents the shift of pixel, and the vertical axis represents the correlation coefficient. For discussion purposes, the second speckle pattern is recorded (or speckle pattern image data is recorded) when the sample 450 is tilted to an angular position other than the reference angular position, e.g., the tilt angle of the sample 450 may be greater than zero degree in absolute value. For discussion purposes, in FIG. 4E, the correlation function 485 is calculated in terms of the rightward shift distance (e.g., in pixels) of the second speckle pattern against the reference speckle pattern. As the positions of the light source 405 and the image sensor 411 are fixed as shown in FIG. 4A, the maximum correlation coefficient (or peak value) of the correlation function 485 may still occur when the shift distance is zero. As the shift distance increases, the correlation coefficient quickly decreases to zero. The maximum correlation coefficient of the correlation function 485 is about 0.85, which is smaller than the maximum correlation coefficient 1.0 of the correlation function 480 shown in FIG. 4D. A decrease in the maximum correlation coefficient indicates that the correlation of the second speckle pattern and the reference speckle pattern shown in FIG. 4E is weaker than the correlation of the first speckle pattern and the reference speckle pattern shown in FIG. 4D.

That is, at each angular position as the sample 450 is tilted to different angular positions within the predetermined tilting range, the image sensor 411 may detect one of the scattered beams 430b-430e, record a speckle pattern as a set of speckle pattern image data. Based on the speckle pattern, the controller 455 may calculate the correlation function of the speckle pattern with respect to the reference speckle pattern, and determine a maximum correlation coefficient of the correlation function. Thus, for the predetermined tilting range, the controller 455 may determine respective maximum correlation coefficients corresponding to respective angular positions (or tilt angles θ) of the sample 450. Based on the determined respective maximum correlation coefficients corresponding to the respective tilt angles of the sample 450, the controller 455 may generate a plot based on the maximum correlation coefficients determined at various tilt angles showing a relationship between the maximum correlation coefficients and the tilt angles θ of the sample 450.

FIG. 4F illustrates a plot showing an exemplary relationship between the maximum correlation coefficients and the tilt angles θ of the sample 450, according to an embodiment of the present disclosure. A curve 490 may be referred to as a correlation profile (or maximum correlation profile, maximum correlation coefficient function) 490 of the sample 450. The correlation profile shows the relationship between the maximum correlation coefficients and the tilt angles. Each point on the curve 490 is the maximum correlation coefficient corresponding to a specific tilt angle. In some embodiments, based on the correlation profile of the sample 450, the controller 455 may determine the respective contributions of the volumetric scattering and the surface scattering in the overall measured scattering. In some embodiments, as shown in FIG. 4F, the horizontal axis represents the tilt angle θ (unit: rad) of the sample 450, and the vertical axis represents the maximum correlation coefficient determined at each tilt angle. The tilt angle θ can be positive or negative. In some embodiments, the maximum correlation coefficients may be normalized maximum correlation coefficients. As shown in FIG. 4F, the maximum correlation coefficient is within a range from 1 to 0. When the tilt angle θ is 0°, the maximum correlation coefficient is the greatest, e.g., about 1. As the absolute value of the tilt angle θ increases, the maximum correlation coefficient may first quickly decrease to a certain value (that is greater than 0 and smaller than 1), fluctuate around that value, and then slowly decrease to 0.

In some embodiments, when the sample 450 includes a volumetric scattering source and a surface scattering source, each type of scattering may be presumed to be associated with a correlation profile (indicating a relationship between the maximum correlation coefficients and the tilt angles). To explain the principles, the following descriptions use the simplistic situation where the sample 450 includes a single volumetric scattering layer and a single surface scattering layer. Hence, there is one volumetric scattering correlation profile and one surface scattering correlation profile, and the overall correlation profile of the sample 450 (similar to the plot shown in FIG. 4F) may be a weighted coherent sum of the volumetric scattering correlation profile and the surface scattering correlation profile. Through determining respective weights (or weighting factors) of the volumetric scattering correlation profile and the surface scattering correlation profile from the overall correlation profile, the relative contributions of the volumetric scattering and the surface scattering in the overall scattering of the sample 450 may be determined.

FIG. 5A illustrates a schematic diagram of the sample 450 when the sample 450 has a layered structure (i.e., multi-layer structure), according to an embodiment of the present disclosure. For discussion purposes, FIG. 5A shows that the sample 450 includes three layers of elements. For example, the sample 450 may include a first layer 452, a second layer 454, and a third layer 456. In some embodiments, the first layer 452 may be a substrate, the second layer 454 may be an optical film, and the third layer 456 may be a protecting film (e.g., a Tri-acetyl cellulose (“TAC”) film) for protection purposes. In some embodiments, the optical film (an example of the second layer 454) may include a liquid crystal polymer (“LCP”), and the optical film may be an LCP layer. In some embodiments, the LCP layer may include polymerized (or cross-linked) liquid crystals (“LCs”), polymer-stabilized LCs, a photo-sensitive LC polymer, or any combination thereof. The LCs may include nematic LCs, twist-bend LCs, chiral nematic LCs, smectic LCs, or any combination thereof. In some embodiments, the optical film may be a photo-sensitive polymer layer including a birefringent photo-refractive holographic material other than LCs, such as an amorphous polymer. In some embodiments, the optical film including the LCP layer or the polymer layer (e.g., amorphous polymer layer) may function as a Pancharatnam-Berry phase (“PBP”), a volume Bragg grating (“VBG”) element, or a polarization volume hologram (“PVH”) element. The PVH element may be fabricated based on various methods, such as holographic interference, laser direct writing, ink-jet printing, and various other forms of lithography. Thus, a “hologram” described herein is not limited to creation by holographic interference, or “holography.”

The optical film (an example of the second layer 454) may be configured with a predetermined optical function. The optical film may function as a transmissive or reflective optical element, such as a prism, a lens or lens array, a grating, a polarizer, a compensation plate, or a phase retarder, etc. The optical film may include one or more layers of films. The thickness of the optical film may be within a range from several micrometers (“μm”) to several hundreds of micrometers. For example, the thickness of the optical film may be within a range from 5 μm to 50 μm, 5 μm to 60 μm, 5 μm to 70 μm, 5 μm to 80 μm, 5 μm to 90 μm, 5 μm to 100 μm, 10 μm to 50 μm, 10 μm to 60 μm, 10 μm to 70 μm, 10 μm to 80 μm, 10 μm to 90 μm, 10 μm to 100 μm, or 5 μm to 200 μm, etc.

The substrate (an example of the first layer 452) may provide support and protection to various layers, films, and/or structures formed thereon. In some embodiments, the substrate may be at least partially transparent in the visible wavelength range (e.g., about 380 nm to about 700 nm). In some embodiments, the substrate may be at least partially transparent in at least a portion of the infrared (“IR”) band (e.g., about 700 nm to about 2 mm). The substrate may include a suitable material that is at least partially transparent to lights of the above-listed wavelength ranges, such as, a glass, a plastic, a sapphire, or a combination thereof, etc. The substrate may be rigid, semi-rigid, flexible, or semi-flexible. The substrate may include a flat surface or a curved surface, on which the different layers or films may be formed. In some embodiments, the substrate may be a part of another optical element or device (e.g., another opto-electrical element or device), e.g., the substrate may be a solid optical lens, a part of a solid optical lens, or a light guide (or waveguide), etc. For example, the substrate (an example of the first layer 452) may be the light guide 310 shown in FIG. 3, and the optical film (an example of the second layer 454) may be the in-coupling grating 335, the out-coupling grating 345, or the redirecting grating 340.

In some embodiments, the sample 450 may include more than three layers. For example, in some embodiments, the sample 450 may include an alignment structure (not shown) disposed between the first layer 452 (e.g., substrate) and the second layer 454 (e.g., optical film). The alignment structure may provide a predetermined alignment pattern to align the molecules in the optical film. The alignment structure may include any suitable alignment structure, such as a photo-alignment material (“PAM”) layer, a mechanically rubbed alignment layer, an alignment layer with anisotropic nanoimprint, an anisotropic relief, or a ferroelectric or ferromagnetic material layer, etc.

For discussion purposes, in the sample 450 having a layered structure, the first layer (e.g., substrate) 452 is presumed to be substantially scattering-free, the second layer (e.g., optical film) 454 is presumed to be a volumetric scattering source, and the third layer (e.g., TAC film) 456 is presumed to be a surface scattering source. The thickness of the third layer (e.g., surface scattering layer) 456 may be at the same scale as the incidence wavelength λ (e.g., hundreds of nanometers), while the thickness of the second layer (e.g., volumetric scattering layer) 454 may be much greater than the incidence wavelength k, e.g., several micrometers to several tens of micrometers. Thus, the memory effect range of the third layer (e.g., surface scattering layer) 456 may be much greater than (e.g., ten times to one hundred times) the memory effect range of the second layer (e.g., volumetric scattering layer) 454.

FIG. 5B illustrates volumetric scattering from the second layer 454 of the sample 450, according to an embodiment of the present disclosure. FIG. 5C illustrates a simulated correlation profile (or maximum correlation coefficient function) 510 of the second layer 454, according to an embodiment of the present disclosure. As shown in FIG. 5C, the horizontal axis represents the tilt angle θ of the second layer 454 (or the sample 450), and the vertical axis represents the maximum correlation coefficient S1 of the second layer 454. The correlation profile 510 in FIG. 5C shows that the maximum correlation coefficient S1 is the greatest (e.g., equal to C1) when the tilt angle θ is zero degree, and then quickly decreases to 0 when the absolute value of the tilt angle θ increases to θ1. The memory effect range of the second layer 454 may be considered as about 2*θ1 (unit: rad).

FIG. 5D illustrates surface scattering from the third layer 456 of the sample 450 shown in FIG. 5A, according to an embodiment of the present disclosure. FIG. 5E illustrates a simulated correlation profile (or maximum correlation coefficient function) 520 of the third layer 456, according to an embodiment of the present disclosure. As shown in FIG. 5E, the horizontal axis represents the tilt angle θ of the third layer 456 (or the sample 450), and the vertical axis represents the maximum correlation coefficient S2 of the third layer 456. The correlation profile 520 in FIG. 5E shows that the maximum correlation coefficient S2 is the greatest (e.g., equal to C2) when the tilt angle θ is zero degree, and then slowly decreases to zero (or smaller than a predetermined coefficient value, which may be set to be close to 0, such as 0.01, 0.005, etc.) when the absolute value of the tilt angle θ increases to θ2. The memory effect range of the third layer 456 may be considered as about 2*θ2 (unit: rad).

Referring to FIGS. 5B-5E, as the memory effect range of the second layer (e.g., volumetric scattering layer) 454 is substantially narrow (e.g., less than 0.1 rad), while the memory effect range of the third layer (e.g., surface scattering layer) 456 is much greater than (e.g., ten times to one hundred times of) the memory effect range of the second layer (e.g., volumetric scattering layer) 454, 02 may be much greater than θ1, and the correlation profile 510 in FIG. 5C may have a much faster decay from the maximum correlation coefficient to zero than the correlation profile 520 in FIG. 5C.

FIG. 5F illustrates overall scattering of the sample 450 shown in FIG. 5A, according to an embodiment of the present disclosure. FIG. 5G illustrates an overall correlation profile (or overall maximum correlation coefficient function) 530 of the sample 450, according to an embodiment of the present disclosure. As shown in FIG. 5G, the horizontal axis represents the tilt angle θ of the sample 450, and the vertical axis represents the maximum correlation coefficient S0 of the sample 450. The maximum correlation coefficients shown in FIG. 5G may be normalized maximum correlation coefficients. For the sample 450 including both of the third layer (e.g., surface scattering layer) 456 and the second layer (e.g., volumetric scattering layer) 454, an overall scattered wavefront at the output plane of the (e.g., at plane B) of the sample 450 may result from the interference of the scattered wavefront generated by the third layer 456 and the scattered wavefront generated by the second layer 454. As a result, the overall correlation profile 530 of the sample 450 shown in FIG. 5F may be a weighted coherent sum of the correlation profile 510 of the second layer 454 shown in FIG. 5C and the correlation profile 520 of the third layer 456 shown in FIG. 5E. In other words, the maximum correlation coefficient S0 shown in FIG. 5G may be a weighted coherent sum of the maximum correlation coefficient S1 shown in FIG. 5C and the maximum correlation coefficient S2 shown in FIG. 5E.

It is noted that the correlation profiles 510, 520, and 530 shown in FIGS. 5C, 5E, and 5G are for showing that the overall correlation profile 530 is a weighted coherent sum of the correlation profile 510 and the correlation profile 520. The correlation profiles 510 and 520 shown in FIGS. 5C and 5E are not actually obtained or determined by the controller 455 in the scattering measurement of the sample 450. Rather, the controller 455 may only obtain or determine the overall correlation profile 530, based on the plurality of speckle patterns recorded by the image sensor 411 (i.e., based on the speckle pattern image data generated by the image sensor 411).

As the overall correlation profile 530 of the sample 450 is a weighted coherent sum of the correlation profile 510 of the second layer 454 and the correlation profile 520 of the third layer 456, through determining respective weights of the hypothetical correlation profile 510 (or maximum correlation coefficient S1) and the hypothetical correlation profile 520 (or maximum correlation coefficient S2) in the overall correlation profile 530 (or maximum correlation coefficient S0), the relative contributions of the volumetric scattering from the second layer 454 and the surface scattering from the third layer 456 in the overall scattering of the sample 450 may be determined. For example, in some embodiments, based on the overall correlation profile 530 of the sample 450, the controller 455 may first determine respective memory effect ranges of the third layer 456 and the second layer 454 via a suitable data or image processing algorithm, and then determine the respective weights for the correlation profile 510 and the correlation profile 520 from the overall correlation profile 530 via a pre-built model, algorithm, or prior knowledge of the sample 450. For example, the controller 455 may first determine at least one tilt angle representing one or more respective memory effect ranges of the third layer 456 and/or the second layer 454 via a suitable data or image processing algorithm.

For illustrative purposes, the correlation profile 530 in FIG. 5G shows that the maximum correlation coefficient S0 is the greatest (e.g., equal to C0, and C0=1) when the tilt angle θ is zero degree. As the absolute value of the tilt angle θ gradually increases to θ3 from zero degree, the maximum correlation coefficient S0 may first quickly decrease, then fluctuate, which may be resulted from the interference of the scattered wavefront generated by the third layer 456 and the scattered wavefront generated by the second layer 454. The correlation profile 530 in FIG. 5G shows that the maximum correlation coefficient S0 is equal to C3 (that is smaller than 1 and greater than 0) when the absolute value of the tilt angle θ is θ3. As the absolute value of the tilt angle θ further increases to θ4 from θ3, the maximum correlation coefficient S0 may substantially monotonically and slowly decay to zero from C3. The maximum correlation coefficient S0 may have a much faster decay from C0 (e.g., 1) to C3 than from C3 to 0, as the memory effect range of the third layer (surface scattering layer) 456 is often much greater than (e.g., ten times to one hundred times) the memory effect range of the second layer (volumetric scattering layer) 454. When the absolute value of the tilt angle θ is greater than θ3 (or θ1) and less than θ4 (or θ2), the maximum correlation coefficient S0 (or the overall correlation profile 530) may be primarily from the maximum correlation coefficient S2 (or the correlation profile 520), as the maximum correlation coefficient S1 (or the correlation profile 510) has decayed to be substantially zero (note θ3 is θ1 shown in FIG. 5C).

In some embodiments, the controller 455 may determine the tilt angle θ4 (corresponding to θ2 in FIG. 5E) at which the maximum correlation coefficients S0 is substantially zero as the tilt angle that reflects or is representative of the memory effect range relating to the surface scattering of the third layer 456. The controller 455 may determine that the memory effect range of the third layer 456 is about 2*θ4. In some embodiments, the controller 455 may determine the tilt angle θ3 (corresponding to θ1 in FIG. 5C) as the tilt angle that reflects or that is representative of the memory effect range relating to the volumetric scattering of the second layer 454. The controller 455 may determine that the memory effect range of the second layer 454 is about 2*θ3. The controller 455 may determine the tilt angle θ3 from the overall correlation profile 530 via a suitable data or image processing algorithm. For example, in some embodiments, as shown in FIG. 5G, the controller 455 may determine a full width half maximum (“FWHM”) of the main peak of the overall correlation profile 530 and estimate θ3 based on angles related to the FWHM. In some embodiments, the controller 455 may determine the FWHM of the main peak of the overall correlation profile 530 by fitting the main peak by a Sinc function or Gaussian function, and determine the memory effect range of the second layer 454 based on the obtained fitting parameters. In some embodiments, the controller 455 may determine a rate of change of the maximum correlation coefficients S0 for each tilt angle. In some embodiments, the controller 455 may determine the tilt angle θ3 (corresponding to θ1 in FIG. 5C) from which the rate of change of the maximum correlation coefficients S0 is smaller than a predetermined threshold rate of change as the tilt angle that reflects or that is representative of the memory effect range relating to the volumetric scattering of the second layer 454. The memory effect range (2*θ3) of the second layer 454 may be substantially narrow, and the memory effect range (2*θ4) of the third layer 456 may be much greater than (e.g., ten times to one hundred times) the memory effect range (2*θ3) of the second layer 454. That is, θ4 may be much larger than θ3.

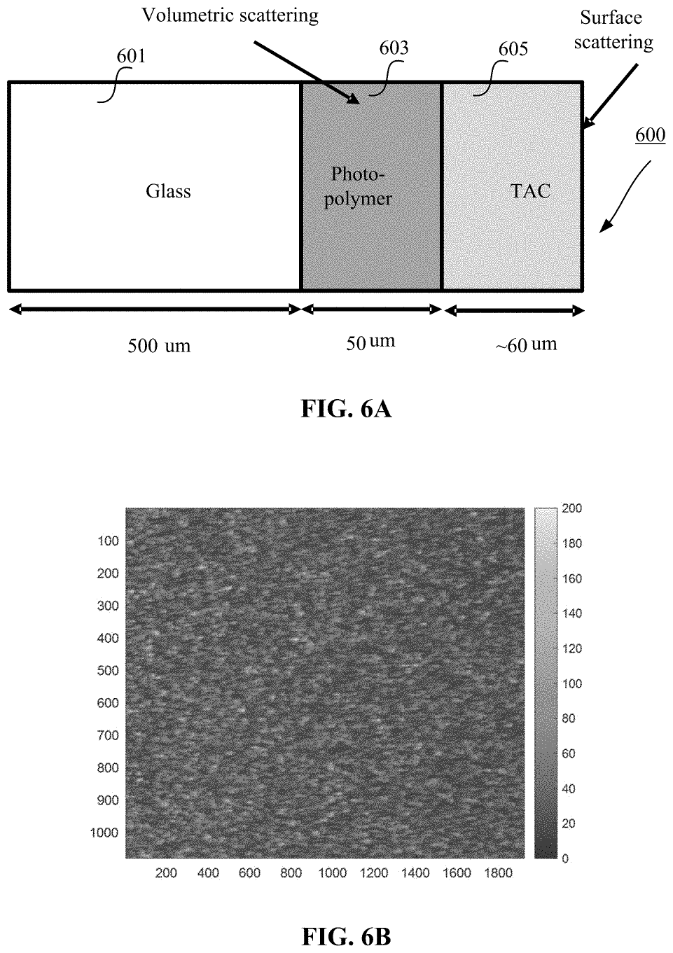

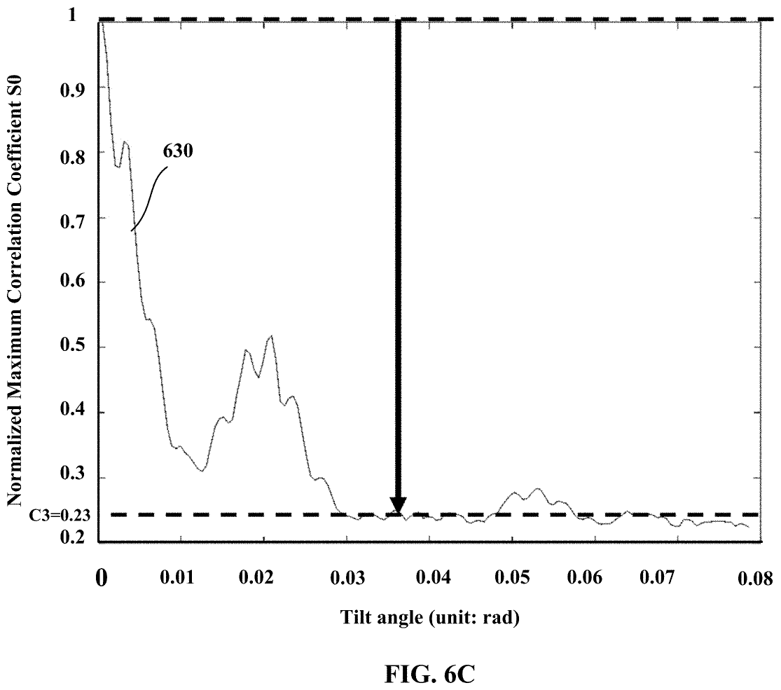

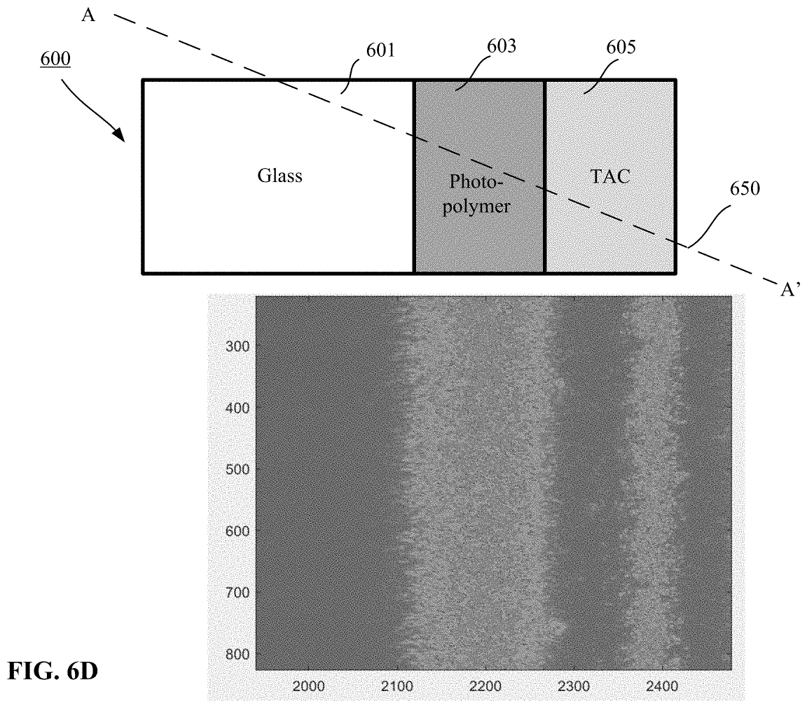

In some embodiments, based on at least one of the determined tilt angles θ3 and θ4, a value C3 may be determined as the weight of the correlation profile 520 (or maximum correlation coefficient S2) in the overall correlation profile 530 (or maximum correlation coefficient S0). The weight for the correlation profile 510 (or maximum correlation coefficient S1) in the overall correlation profile 530 (or maximum correlation coefficient S0) may be calculated as (C0−C3), e.g., (1−C3) when C0=1. In some embodiments, when the maximum correlation coefficients S0 are not normalized maximum correlation coefficients, C0 may be equal to a maximum value of the plurality of the maximum correlation coefficients S0 (or a peak value of the overall correlation profile 530). After the weight for the correlation profile 520 is determined as C3, the weight for the correlation profile 510 may be determined as a difference between the maximum value of the plurality of the maximum correlation coefficients in the overall correlation profile 530 and the weight for the correlation profile 520, i.e., C0-C3. Example methods for determining the value C3 will be discussed in connection with FIG. 6C.

The weights for the correlation profile 510 and the correlation profile 520 in the overall correlation profile 530 indicate the relative contributions of the volumetric scattering from the second layer 454 and the surface scattering from the third layer 456 that resulted in the overall scattering of the sample 450, respectively. For example, if the overall scattering of the sample 450 is presumed to be 1, the weight of the volumetric scattering from the second layer 454 may be determined as the weight of the correlation profile 510 in the overall correlation profile 530, and the weight of the surface scattering from the third layer 456 may be determined as the weight of the correlation profile 520 in the overall correlation profile 530. Thus, the relative contribution of the surface scattering in the overall scattering of the sample 450 may be C3, and the relative contribution of the volumetric scattering in the overall scattering of the sample 450 may be C0−C3 (or 1−C3 if C0=1).

The determined weights of the volumetric scattering from the second layer 454 and the surface scattering from the third layer 456 from the overall scattering of the sample 450 may provide guidance for improving the fabrication quality of the sample 450. Based on the determined weights of the volumetric scattering and the surface scattering, the controller 455 may determine a dominant scattering of the sample 450. For example, when the weight of the surface scattering from the third layer 456 is greater than 0.5 (e.g., when C3>0.5), the controller 455 may determine that the surface scattering is the dominant scattering of the sample 450. Thus, polishing or other types of surface treatment of the third layer 456 may be recommended to reduce the overall scattering of the sample 450. When the weight of the volumetric scattering from the second layer 454 is greater than 0.5 (e.g., 1−C3>0.5), the controller 455 may determine that the volumetric scattering is the dominant scattering of the sample 450. Thus, adjusting the material formulation for fabricating the second layer 454 may be recommended to reduce the overall scattering of the sample 450.

FIG. 6A illustrates an x-z sectional view of an optical component 600 with a layered structure, the scattering of which may be measured by the system 400 shown in FIG. 4A, according to an embodiment of the present disclosure. As shown in FIG. 6A, the optical component 600 has a layered structure with three layers, including a glass substrate 601, a photo-polymer layer 603 disposed at a surface of the glass substrate 601, and a TAC layer 605 disposed at a surface of the photo-polymer layer 603. The thicknesses of the glass substrate 601, the photo-polymer layer 603, and the TAC layer 605 are about 500 μm, 50 μm, and 60 μm, respectively. The light scattering of the optical component 600 may be measured via the system 400 shown in FIG. 4A.

After the optical component 600 is tilted at a predetermined increment throughout the predetermined tilting range, the image sensor 411 may record a plurality of speckle patterns (in form of a plurality of sets of speckle pattern image data) associated with a plurality of tilt angles of the sample 450. In some embodiments, the image sensor 411 may generate a plurality of images of the speckle patterns. It is understood that the image sensor 411 may not generate the images. The image sensor 411 may provide the sets of speckle pattern image data to the controller 455, which may analyze the speckle pattern image data and determine the relative contributions of the volumetric scattering and the surface scattering based on the processes disclosed herein. For illustrative purposes, FIG. 6B illustrates an image of a speckle pattern of the optical component 600 generated by the image sensor 411 (or the controller 455) included in the system 400 shown in FIG. 4A, according to an embodiment of the present disclosure. As shown in FIG. 6B, the horizontal axis and the vertical axis represents the positions of the pixels of the image. The light intensity distribution of the speckle pattern is represented by gray scales, in which the darker gray indicates a lower light intensity, and the lighter gray indicates a higher light intensity. The image of the speckle pattern may be generated when the optical component 600 is at the reference angular position, or when the optical component 600 is tilted to be at an angular position other than the reference angular position.

FIG. 6C illustrates a correlation profile 630 of the optical component 600 that may be generated by the controller 455, according to an embodiment of the present disclosure. As shown in FIG. 6C, the horizontal axis represents the tilt angle θ of the optical component 600, and the vertical axis represents the normalized maximum correlation coefficient S0 of the optical component 600. For discussion purposes, the correlation profile 630 may also be referred to as a tilt angle dependent correlation profile herein. The maximum correlation coefficient S0 is the greatest (e.g., equal to 1) when the tilt angle θ is zero degree. As the tilt angle θ gradually increases, the maximum correlation coefficient S0 may first quickly decrease, then fluctuate. The maximum correlation coefficient S0 is about 0.23 when the tilt angle θ is about 0.03 rad. When the tilt angle θ gradually increases from 0.03 rad to 0.08 rad, the maximum correlation coefficient S0 is substantially maintained at an average value of 0.23 (may be referred to as a base line of the correlation profile 630 for tilt angles from 0.03 rad to 0.08 rad). The value C3 shown in FIG. 6C may be 0.23.

In the example of FIG. 6C, various pre-built models, algorithms, or prior knowledge of the sample 450 may be used to determine the value C3. For example, in some embodiments, the controller 455 may determine the tilt angle θ3 (corresponding to θ1 in FIG. 5C) as the tilt angle that reflects or that is representative of the memory effect range relating to the volumetric scattering of the second layer 454. The controller 455 may determine that the memory effect range of the second layer 454 is about 2*θ3. The controller 455 may determine the tilt angle θ3 from the overall correlation profile 530 via a suitable data or image processing algorithm. For example, in some embodiments, as shown in FIG. 5G, the controller 455 may determine a full width half maximum (“FWHM”) of the main peak of the overall correlation profile 530, and determine a range of the tilt angle corresponding to the FWHM of the main peak of the overall correlation profile 530 for an estimation of θ3. In some embodiments, the controller 455 may determine the FWHM of the main peak of the overall correlation profile 530 by fitting the main peak by a sinc function or Gaussian function, and determine the memory effect range (2*θ3) of the second layer 454 based on the obtained fitting parameters. In some embodiments, the controller 455 may calculate the rate of change of the normalized maximum correlation coefficient S0 at each tilt angle. When the rate of change (absolute value) is smaller than a predetermined threshold rate of change (which may be a small number close to zero, such as 0.1), the corresponding tilt angle (e.g., 0.03 rad) may be determined. The value of the normalized maximum correlation coefficient S0 (here 0.23) corresponding to the tilt angle of 0.03 rad may be determined to be C3. In some embodiments, a sub-range within the range from θ3 (here 0.03 rad) and θ4 (which may be larger than 0.08 rad) may be selected, for example, from 0.03 rad to 0.06 rad. Within this range, the rate of change at each tilt angle may be smaller than the predetermined threshold rate of change. An average value of the normalized maximum correlation coefficients for the selected tilt angle range 0.03 rad to 0.06 rad may be calculated, and this average value (which is presumed to be 0.23 for discussion purposes) may be used as C3.

Based on the correlation profile 630 of the optical component 600, the controller 455 may determine the weights for the volumetric scattering from the photo-polymer layer 603 and the surface scattering from the TAC layer 605 in the overall scattering of the optical component 600. For example, the overall scattering of the optical component 600 is presumed to be 1. According to FIG. 6C, the weight of the surface scattering from the TAC layer 605 in the overall scattering of the optical component 600 may be determined as about 0.23, and the weight of the volumetric scattering from the photo-polymer layer 603 in the overall scattering of the optical component 600 determined as about 0.78 (i.e., 1−0.23=0.78). Thus, the volumetric scattering from the photo-polymer layer 603 may be identified as the dominant scattering in the optical component 600.

To corroborate that the volumetric scattering from the photo-polymer layer 603 is the dominant scattering in the optical component 600, the light scattering of the optical component 600 is measured by another type of mechanism using a light-sheet microscope. FIG. 6D illustrates a light intensity image of a selected cross section of the optical component 600 obtained by a light-sheet microscope, according to an embodiment of the present disclosure. A light-sheet microscope typically includes an illumination device and a detection device. A single slice of the optical component 600, e.g., an A-A′ section of the optical component 600, is illuminated with a thin sheet of laser beam (i.e., light sheet) generated by the illumination device, and is imaged onto the detection device. The light intensity image shows the light intensity distribution of lights forwardly scattered from cross-sectional slices of different layers of the optical component 600. As shown in FIG. 6D, the horizontal axis represents the position (unit: μm) along an illumination optical axis 650, and the vertical axis represents the position (unit: μm) along a thickness direction of the optical component 600. The light intensity distribution is represented by gray scales, in which the darker gray indicates a lower light intensity, and the lighter gray indicates a higher light intensity. FIG. 6D shows that when illuminated by the light sheet, the forward scattering of the optical component 600 primarily occurs in the volume of the photo-polymer layer 603, and at an interface between the TAC layer 605 and the air, as indicated by the relatively high light intensity in the photo-polymer layer 603 and at the interface between the TAC layer 605 and the air. The scattering provided by the volumes of the glass substrate 601 and the TAC layer 605 is negligible. In addition, FIG. 6D shows that the scattering in the volume of the photo-polymer layer 603 is much stronger than the scattering at the interface between the TAC layer 605 and the air. That is, the volumetric scattering from the photo-polymer layer 603 may be the dominant scattering in the optical component 600, which matches with the result obtained according to the correlation profile 630 of the optical component 600 shown in FIG. 6C.

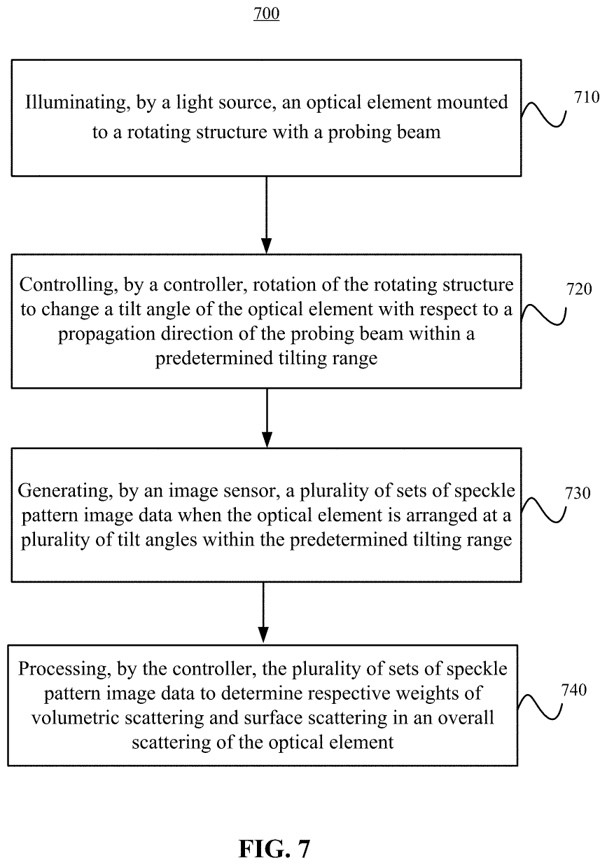

The present disclosure also provides a method for separately identifying the contributions of the volumetric scattering and the surface scattering from an overall scattering of an optical element or component based on “optical memory effect.” The method may be performed by one or more components included in the disclosed system. Descriptions of the components, structures, and/or functions can refer to the above descriptions rendered in connection with FIGS. 4A-6D. FIG. 7 is a flowchart illustrating a method 700 for measuring scattering of an optical element (or component) and determining respective weights of volumetric scattering and surface scattering in an overall scattering of the optical element, according to an embodiment of the present disclosure.

As shown in FIG. 7, the method 700 may include illuminating, by a light source, an optical element mounted to a rotating structure with a probing beam (step 710). The optical element may scatter the probing beam as one or more scattered beams. The method 700 may include controlling, by a controller, rotation of the rotating structure to change a tilt angle of the optical element with respect to a propagation direction of the probing beam within a predetermined tilting range (step 720). The tilt angle of the optical element may be defined as an angle formed between a reference axis of the optical element and a propagation direction of the probing beam, as described above in connection with FIGS. 4A-4C.

The method 700 may include generating, by an image sensor, a plurality of sets of speckle pattern image data when the optical element is arranged at a plurality of tilt angles within the predetermined tilting range (step 730). Each set of speckle pattern image data may represent a speckle pattern of the scattered beams output from the optical element. Each set of speckle pattern image data may be generated by the image sensor based on the scattered beams received by the image sensor. In some embodiments, the imaging sensor may be a camera sensor that includes a 2D array of pixels for imaging.

The optical element may include a surface scattering source and a volumetric scattering source. The method 700 may include processing, by the controller, the plurality of sets of speckle pattern image data to determine weights of volumetric scattering and surface scattering in an overall scattering of the optical element (step 740). An example process of determining the weights is discussed above in connection with FIG. 6C.

In some embodiments, the step 740 may include, for each tilt angle, determining a correlation function of a corresponding speckle pattern with respect to a reference speckle pattern. In some embodiments, the reference speckle pattern image data for the reference speckle pattern may be recorded or generated by the image sensor when the tilt angle of the optical element is zero degree. The determination of the correlation function may be based on the speckle pattern image data for the tilt angle and the reference speckle pattern image data for the reference speckle pattern. A plurality of correlation functions may be determined for the plurality of tilt angles.

In some embodiments, the step 740 may include, for each correlation function, determining a maximum correlation coefficient for the specific tilt angle. Thus, a plurality of maximum correlation coefficients may be determined for the plurality of tilt angles. In some embodiments, the step 740 may include normalizing the plurality of determined maximum correlation coefficients to obtain a plurality of normalized maximum correlation coefficients.

In some embodiments, the step 740 may include determining respective memory effect ranges of the surface scattering source and the volumetric scattering source based on the plurality of tilt angles and the plurality of normalized maximum correlation coefficients. Determining each memory effect range may include determining a tilt angle that reflects or that is representative of the memory effect range. For example, in some embodiments, the step 740 may include determining a first tilt angle (e.g., 04 shown in FIG. 5G) at which the normalized maximum correlation coefficient is substantially zero as the tilt angle that reflects or that is representative of the memory effect range of the surface scattering source. In some embodiments, the step 740 may include determining a second tilt angle (e.g., θ3 shown in FIG. 5G) as the tilt angle that reflects or that is representative of the memory effect range of the volumetric scattering source. In some embodiments, determining the second tilt angle may include determining, based on the plurality of normalized maximum correlation coefficients for the plurality of tilt angles, an overall correlation profile of the optical element; and determining a full width half maximum (“FWHM”) of a main peak of the overall correlation profile, and determining the second tilt angle based on one or more tilt angles related to the FWHM. In some embodiments, determining the FWHM of the main peak of the overall correlation profile may include fitting the main peak of the overall correlation profile by a sinc function or Gaussian function. In some embodiments, determining the second tilt angle may include determining the memory effect range of the second layer 454 based on obtained fitting parameters. The second tilt angle may be smaller than the first tilt angle. Once the first tilt angle and the second tilt angle are determined, the respective memory effect ranges of the surface scattering source and the volumetric scattering source may be determined. For example, the memory effect range of the surface scattering source may be two times the first tilt angle, and the memory effect range of the volumetric scattering source may be two times the second tilt angle.

In some embodiments, the step 740 may include based on at least one tilt angle reflecting (or representative of) at least one of the memory effect ranges of the surface scattering source and the volumetric scattering source, determining respective weights of surface scattering and volumetric scattering in an overall scattering of the optical element. For example, in some embodiments, the weight of the volumetric scattering in the overall scattering of the optical element may be determined to be a normalized maximum correlation coefficient corresponding to the second tilt angle (e.g., θ3). In some embodiments, the weight of the volumetric scattering in the overall scattering of the optical element may be determined as an average of the normalized maximum correlation coefficients corresponding to tilt angles within a sub-range of a range from the second tilt angle (e.g., θ3) to the first tilt angle (e.g., θ4). In some embodiments, determining the weight of the surface scattering in the overall scattering of the optical element may include determining the weight of the surface scattering in the overall scattering as a difference between 1 and the weight of the volumetric scattering in the overall scattering of the optical element.

The method 700 may include other steps or processes not shown in FIG. 7. For example, in some embodiments, after determining respective weights of the surface scattering and the volumetric scattering in the overall scattering of the optical element, the method 700 may include determining a dominant scattering in the overall scattering of the optical element, and providing guidance for process improvements relating to the fabrication of the optical element to reduce the overall scattering.

In some embodiments, the method 700 may also include determining a plurality of exposure times of the imaging sensor for the plurality of tilt angles of the optical element. In some embodiments, the method 700 may also include, based on the determined exposure times for the receptive tilt angles, pre-setting the exposure times in the imaging sensor for the plurality of tilt angles. In some embodiments, the step of pre-setting the exposure times in the imaging sensor may be omitted. In some embodiments, these steps may be performed prior to step 730.

After the respective exposure times of the image senor for the respective tilt angles of the optical element are determined, the step 730 may include generating, by the image sensor, a plurality of sets of speckle pattern image data representing the plurality of speckle patterns, using the respective determined exposure times for the respective tilt angles of the optical element. Each set of speckle pattern image data may include a first set of intensity data relating to the overall scattering detected at a specific tilt angle. For example, the optical element may be tilted from a first angular position corresponding to a first tilt angle to a second angular position corresponding to a second tilt angle. At the first angular position, the imaging sensor may generate a first set of speckle pattern image data representing a first speckle pattern using a first determined exposure time for the first tilt angle. At the second angular position, the imaging sensor may generate a second set of speckle pattern image data representing a second speckle pattern using a second determined exposure time for the second tilt angle.

In some embodiments, after the exposure times for the tilt angles are determined, the method 700 may also include, with the light source turned off, moving the rotating structure to tilt the optical element to each of the plurality of tilt angles to generate a plurality of sets of dark frame speckle pattern image data representing a plurality of dark frame patterns, using the same determined exposure times at the specific tilt angle. Each of the plurality of sets of dark frame speckle pattern image data representing one of the plurality of dark frame patterns may include a second set of intensity data relating to the ambient light in the environment and the intrinsic noise of the imaging sensor. For example, with the light source turned off, the optical element may be tilted from the first angular position to the second angular position. At the first angular position, the imaging sensor may record a first dark frame pattern, using the first determined exposure time for the first tilt angle. At the second angular position, the imaging sensor may record a second dark frame pattern, using the second determined exposure time for the second tilt angle.

In some embodiments, the step 740 may include subtracting the second sets of intensity data from the corresponding first sets of intensity data to obtain a plurality of third sets of intensity data for the plurality of tilt angles. The step 740 may include normalizing the third sets of intensity data by the corresponding exposure times for the plurality of tilt angles. For example, a second set of intensity date representing the first dark frame pattern may be subtracted from a first set of intensity date representing the first speckle pattern to obtain a third set of intensity data for the first tilt angle. The third set of intensity data for the first angular position may be normalized by the first determined exposure time for the first tilt angle. A second set of intensity date representing the second dark frame pattern may be subtracted from a first set of intensity date representing the second speckle pattern to obtain a third set of intensity data for the second tilt angle. The third set of intensity data for the second tilt angle may be normalized by the second determined exposure time for the second tilt angle. In some embodiments, the step 740 may include processing the normalized third sets of intensity data to obtain a correlation profile of the optical element that depends on the tilt angle, i.e., a relationship between the normalized third sets of intensity data and tilt angles.

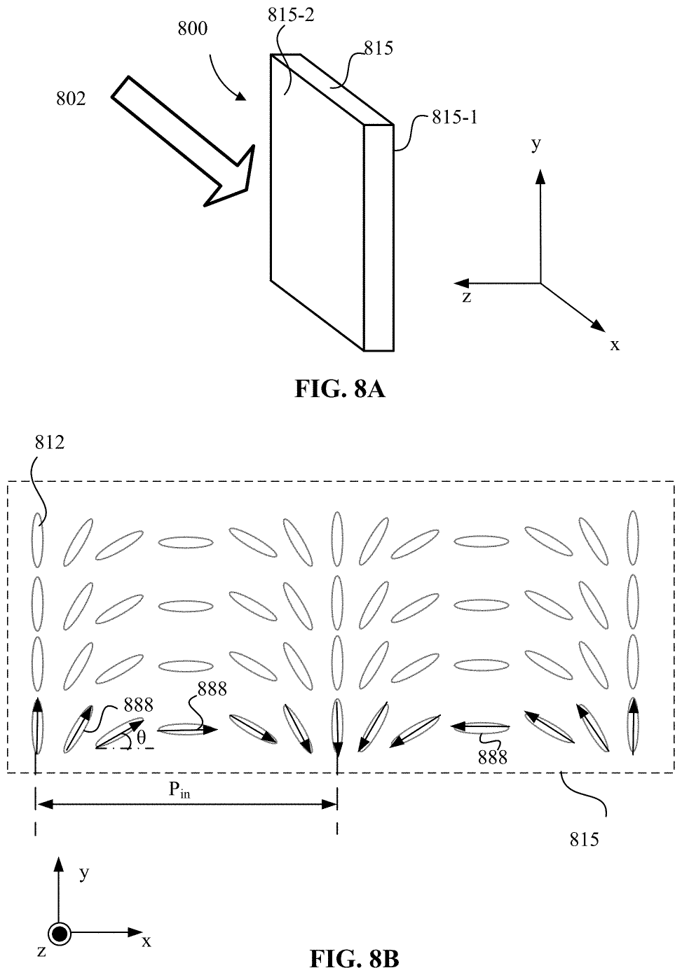

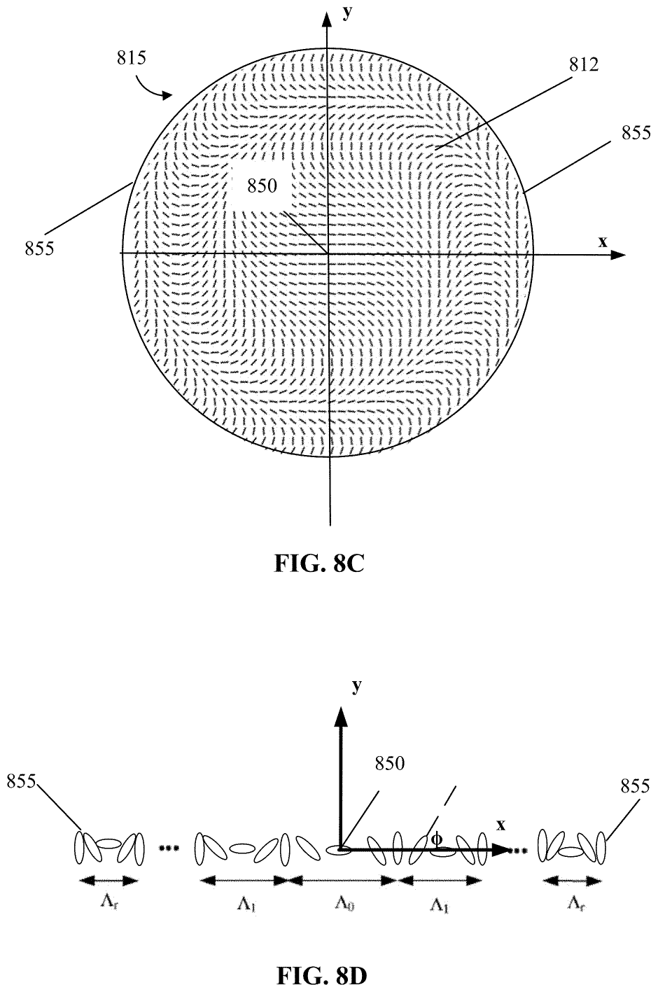

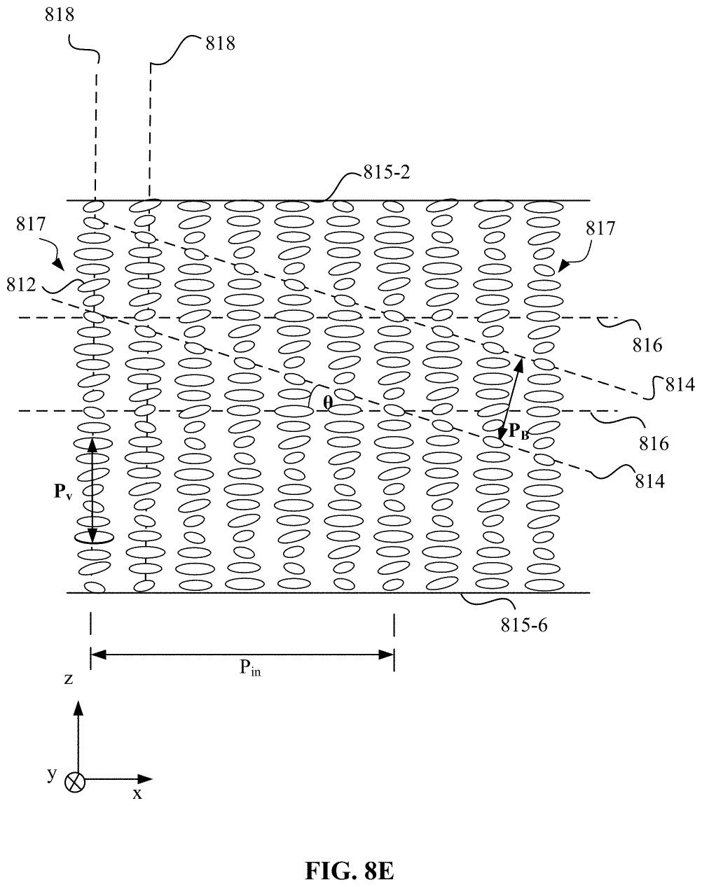

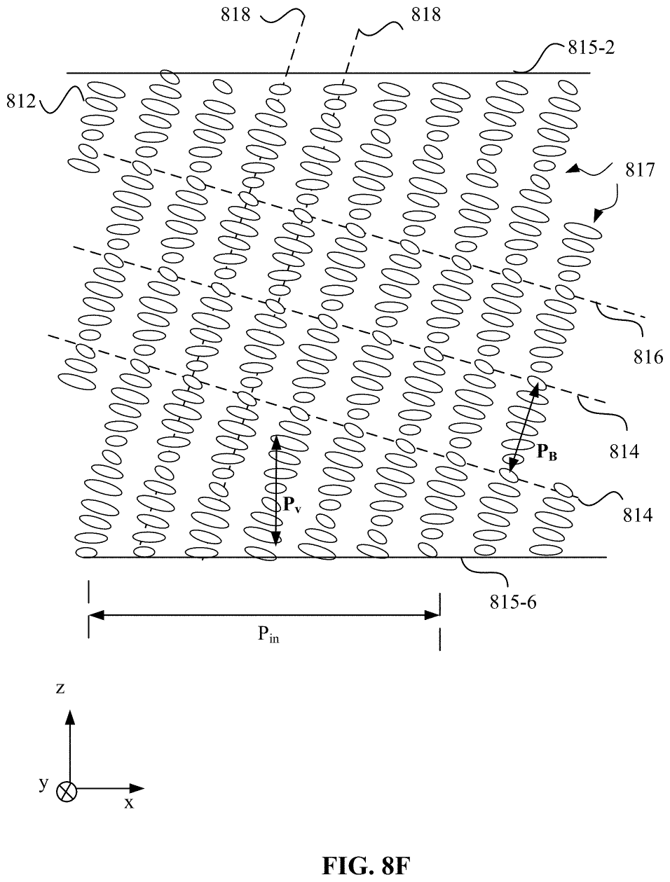

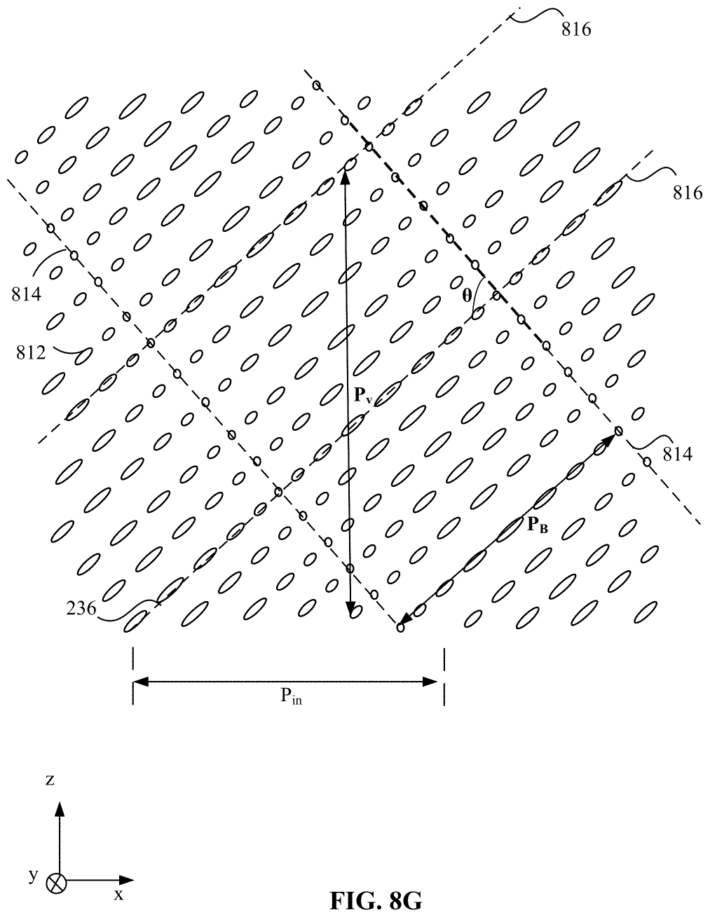

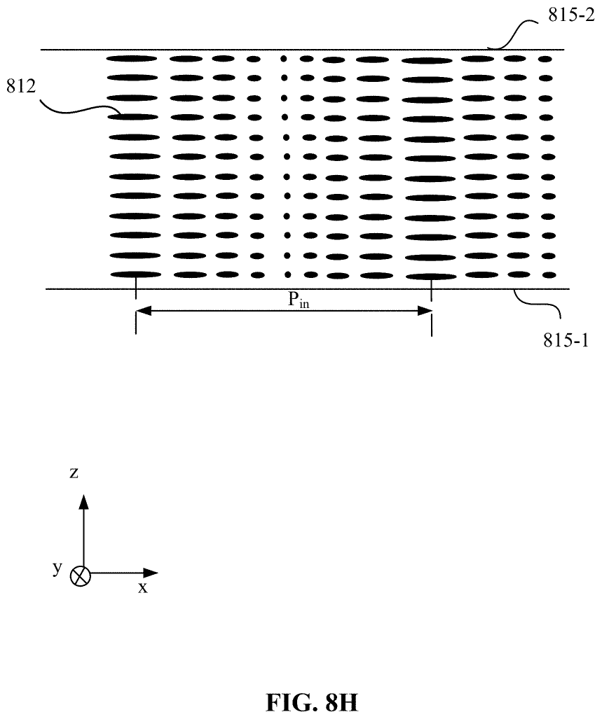

FIG. 8A illustrates a schematic three-dimensional (“3D”) view of an optical film 800 that may be included in an optical component (or optical element) disclosed herein, to which the disclosed scattering measurement system and method may be applied to separately determine the contribution of the volumetric scattering and surface scattering. For example, the optical film 800 may be the second layer 454 included in the sample 450 shown in FIG. 5A, or the second layer 603 included in the sample 600 shown in FIG. 6A. The optical component may include a layered structure with multiple layers or a single-layer structure with a single layer. A light 802 may be obliquely incident onto the optical film 800. FIGS. 8B-8D schematically illustrate various views of a portion of the optical film 800 shown in FIG. 8A, showing in-plane orientations of optically anisotropic molecules in the optical film 800, according to various embodiments of the present disclosure. FIGS. 8E-8H schematically illustrate various views of a portion of the optical film 800 shown in FIG. 8A, showing out-of-plane orientations of optically anisotropic molecules in the optical film 800, according to various embodiments of the present disclosure.

As shown in FIG. 8A, although the optical film 800 is shown as having a rectangular plate shape for illustrative purposes, the optical film 800 may have any suitable shape, such as a circular shape. In some embodiments, one or both surfaces along the light propagating path of the light 802 may have curved shapes. In some embodiments, the optical film 800 may include a layer of a birefringent medium 815 with intrinsic or induced (e.g., photo-induced) optical anisotropy, such as liquid crystals, liquid crystal polymers, amorphous polymers. The optical film 800 may also be referred to as a birefringent medium layer 800.

In some embodiments, the optical film 800 may be a polymer layer (or film). For example, in some embodiments, the optical film 800 may be a liquid crystal polymer (“LCP”) layer. In some embodiments, the LCP layer may include polymerized (or cross-linked) LCs, polymer-stabilized LCs, photo-reactive LC polymers, or any combination thereof. The LCs may include nematic LCs, twist-bend LCs, chiral nematic LCs, smectic LCs, or any combination thereof. In some embodiments, the optical film 800 may be a polymer layer including a birefringent photo-refractive holographic material other than LCs, such as an amorphous polymer. The optical film 800 may have a first surface 815-1 on one side and a second surface 815-2 on an opposite side. The first surface 815-1 and the second surface 815-2 may be surfaces along the light propagating path of the incident light 802. In some embodiments, the first surface 815-1 may be an interface between the optical film 800 and a substrate (e.g., the substrate may be the first layer 452 shown in FIG. 5A) (or an alignment structure) on which the optical film 800 is formed, and the second surface 815-2 may be an interface between the optical film 800 and a protecting film (e.g., a TAC film) or an outside environment (e.g., air).

The birefringent medium 815 in the optical film 800 may include optically anisotropic molecules (e.g., LC molecules) configured with a three-dimensional (“3D”) orientational pattern. In some embodiments, an optic axis of the birefringent medium 815 or optical film 800 may be configured with a spatially varying orientation in at least one in-plane direction. For example, the optic axis of the LC material may periodically or non-periodically vary in at least one in-plane linear direction, in at least one in-plane radial direction, in at least one in-plane circumferential (e.g., azimuthal) direction, or a combination thereof. The LC molecules may be configured with an in-plane orientation pattern, in which the directors of the LC molecules may periodically or non-periodically vary in the at least one in-plane direction. In some embodiments, the optic axis of the LC material may also be configured with a spatially varying orientation in an out-of-plane direction. The directors of the LC molecules may also be configured with spatially varying orientations in an out-of-plane direction. For example, the optic axis of the LC material (or directors of the LC molecules) may twist in a helical fashion in the out-of-plane direction.

FIGS. 8B-8D schematically illustrate x-y sectional views of a portion of the optical film 800 shown in FIG. 8A, showing in-plane orientations of the optically anisotropic molecules 812 in the optical film 800, according to various embodiments of the present disclosure. The in-plane orientations of the optically anisotropic molecules 812 in the optical film 800 shown in FIGS. 8B-8D are for illustrative purposes. In some embodiments, the optically anisotropic molecules 812 in the optical film 800 may have other in-plane orientation patterns. For discussion purposes, rod-like LC molecules 812 are used as examples of the optically anisotropic molecules 812 of the optical film 800. The rod-like LC molecule 812 may have a longitudinal axis (or an axis in the length direction) and a lateral axis (or an axis in the width direction). The longitudinal axis of the LC molecule 812 may be referred to as a director of the LC molecule 812 or an LC director. An orientation of the LC director may determine a local optic axis orientation or an orientation of the optic axis at a local point of the optical film 800. The term “optic axis” may refer to a direction in a crystal. A light propagating in the optic axis direction may not experience birefringence (or double refraction). An optic axis may be a direction rather than a single line: lights that are parallel to that direction may experience no birefringence. The local optic axis may refer to an optic axis within a predetermined region of a crystal. For illustrative purposes, the LC directors of the LC molecules 812 shown in FIGS. 8B-8D are presumed to be in the surface of the optical film 800 or in a plane parallel with the surface with substantially small tilt angles with respect to the surface.

FIG. 8B schematically illustrates an x-y sectional view of a portion of the optical film 800, showing a periodic in-plane orientation pattern of the orientations of the LC directors (indicated by arrows 888 in FIG. 8B) of the LC molecules 812 located in a film plane (e.g., one of the first surface 815-1 or the second surface 815-2, or a plane within the volume of the optical film 800 parallel with the first surface or the second surface) of the optical film 800. The film plane may be perpendicular to a thickness direction (e.g., a z-axis direction in FIG. 8B) of the optical film 800, and may be within the volume of the optical film 800 or at a surface of the optical film 800. The orientations of the LC directors of the LC molecules 812 in the film plane may exhibit a periodic rotation in at least one in-plane direction (e.g., an x-axis direction). The periodically varying in-plane orientations of the LC directors form a pattern. The in-plane orientation pattern of the LC directors shown in FIG. 8B may also be referred to as an in-plane grating pattern. Accordingly, the optical film 800 may function as a polarization selective grating, e.g., a PVH grating, or a PBP grating, etc.

As shown in FIG. 8B, the LC molecules 812 located in a film plane of the optical film 800 may be configured with orientations of LC directors continuously changing (e.g., rotating) in a predetermined direction (e.g., an x-axis direction) along the surface (or in a plane parallel with the surface). The continuous rotation of orientations of the LC directors may form a periodic rotation pattern with a uniform (e.g., same) in-plane pitch Pᵢₙ. The predetermined direction may be any suitable direction within the film plane of the optical film 800. For illustrative purposes, FIG. 8B shows that the predetermined direction is the x-axis direction. The predetermined direction may be referred to as an in-plane direction, the pitch Pᵢₙ along the in-plane direction may be referred to as an in-plane pitch or a horizontal pitch. The pattern with the uniform (or same) in-plane pitch Pᵢₙ may be referred to as a periodic LC director in-plane orientation pattern. The in-plane pitch Pᵢₙ is defined as a distance along the in-plane direction (e.g., the x-axis direction) over which the orientations of the LC directors exhibit a rotation by a predetermined value (e.g., 180°). In other words, in a region substantially close to (including at) the surface of the optical film 800, local optic axis orientations of the optical film 800 may vary periodically in the in-plane direction (e.g., the x-axis direction) with a pattern having the uniform (or same) in-plane pitch Pᵢₙ.

In addition, within a film plane of the optical film 800, the orientations of the directors of the LC molecules 812 may exhibit a rotation in a predetermined rotation direction, e.g., a clockwise direction or a counter-clockwise direction. Accordingly, the rotation of the orientations of the directors of the LC molecules 812 within a film plane of the optical film 800 may exhibit a handedness, e.g., right handedness or left handedness. In the embodiment shown in FIG. 8B, within the film plane of the optical film 800, the orientations of the directors of the LC molecules 812 may exhibit a rotation in a clockwise direction. Accordingly, the rotation of the orientations of the directors of the LC molecules 812 within the film plane of the optical film 800 may exhibit a left handedness.

Although not shown, in some embodiments, within the film plane of the optical film 800, the orientations of the directors of the LC molecules 812 may exhibit a rotation in a counter-clockwise direction. Accordingly, the rotation of the orientations of the directors of the LC molecules 812 within the film plane of the optical film 800 may exhibit a right handedness. Although not shown, in some embodiments, within the film plane of the optical film 800, domains in which the orientations of the directors of the LC molecules 812 exhibit a rotation in a clockwise direction (referred to as domains DL) and domains in which the orientations of the directors of the LC molecules 812 exhibit a rotation in a counter-clockwise direction (referred to as domains DR) may be alternatingly arranged in at least one in-plane direction, e.g., in x-axis and y-axis directions.

FIG. 8C schematically illustrates an x-y sectional view of a portion of the optical film 800, showing a varying in-plane orientation pattern of the LC directors of the LC molecules 812 located within a film plane of the optical film 800 shown in FIG. 8A. FIG. 8D illustrates a section of the in-plane orientation pattern taken along an x-axis in the optical film 800 shown in FIG. 8C, according to an embodiment of the present disclosure. Within a film plane of the optical film 800, the orientations of the optic axis of the optical film 800 may exhibit a continuous rotation in at least two opposite in-plane directions from a center of the optical film 800 to opposite peripheries of the optical film 800 with a varying pitch. In some embodiments, the in-plane orientation pattern of the orientations of the LC directors shown in FIG. 8C may also be referred to as a lens pattern. Accordingly, the optical film 800 with the LC director orientations shown in FIG. 8C may function as a polarization selective lens, e.g., a PBP lens, or a PVH lens, etc.

As shown in FIG. 8C, the orientations of the LC molecules 812 located within the film plane of the optical film 800 may be configured with an in-plane orientation pattern having a varying pitch in at least two opposite in-plane directions from a lens center 850 to opposite lens peripheries 855. For example, the orientations of the LC directors of LC molecules 812 located within the film plane of the optical film 800 may exhibit a continuous rotation in at least two opposite in-plane directions (e.g., a plurality of opposite radial directions) from the lens center 850 to the opposite lens peripheries 855 with a varying pitch. The orientations of the LC directors from the lens center 850 to the opposite lens peripheries 855 may exhibit a rotation in a same rotation direction (e.g., clockwise, or counter-clockwise). A pitch A of the in-plane orientation pattern may be defined as a distance in the in-plane direction (e.g., a radial direction) over which the orientations of the LC directors (or azimuthal angles ϕ of the LC molecules 812) change by a predetermined angle (e.g., 180°) from a predetermined initial state.

As shown in FIG. 8D, according to the LC director field along the x-axis direction, the pitch A may be a function of the distance from the lens center 850. The pitch A may monotonically decrease from the lens center 850 to the lens peripheries 855 in the at least two opposite in-plane directions (e.g., two opposite radial directions) in the x-y plane, e.g., Λ₀>Λ₁>>Λᵣ. Λ₀ is the pitch at a central region of the lens pattern, which may be the greatest. The pitch Ar is the pitch at a periphery region (e.g., periphery 855) of the lens pattern, which may be the smallest. In some embodiments, the azimuthal angle ϕ of the LC molecule 812 may change in proportional to the distance from the lens center 850 to a local point of the optical film 800 at which the LC molecule 812 is located.

The in-plane orientation patterns of the LC directors shown in FIGS. 8B-8D are for illustrative purposes. The optical film 800 may have any suitable in-plane orientation patterns of the LC directors. For illustrative purposes, FIGS. 8C and 8D show an in-plane orientation pattern of the LC directors when the optical film 800 is a PBP or PVH lens functioning as an on-axis spherical lens. In some embodiments, the optical film 800 may be a PBP or PVH lens functioning as an off-axis spherical lens, a cylindrical lens, an aspheric lens, or a freeform lens, etc.

FIGS. 8E-8H schematically illustrate y-z sectional views of a portion of the optical film 800, showing out-of-plane orientations of the LC directors of the LC molecules 812 in the optical film 800, according to various embodiments of the present disclosure. For discussion purposes, FIGS. 8E-8H schematically illustrate out-of-plane (e.g., along z-axis direction) orientations of the LC directors of the LC molecules 812 when the in-plane (e.g., in a plane parallel to the x-y plane) orientation pattern is a periodic in-plane orientation pattern shown in FIG. 8B. As shown in FIG. 8E, within a volume of the optical film 800, the LC molecules 812 may be arranged in a plurality of helical structures 817 with a plurality of helical axes 818 and a helical pitch Pₕ along the helical axes. The azimuthal angles of the LC molecules 812 arranged along a single helical structure 817 may continuously vary around a helical axis 818 in a predetermined rotation direction, e.g., clockwise direction or counter-clockwise direction. In other words, the orientations of the LC directors of the LC molecules 812 arranged along a single helical structure 817 may exhibit a continuous rotation around the helical axis 818 in a predetermined rotation direction. That is, the azimuthal angles associated with the LC directors may exhibit a continuous change around the helical axis in the predetermined rotation direction. Accordingly, the helical structure 817 may exhibit a handedness, e.g., right handedness or left handedness. The helical pitch Pₕ may be defined as a distance along the helical axis 818 over which the orientations of the LC directors exhibit a rotation around the helical axis 818 by 360°, or the azimuthal angles of the LC molecules vary by 360°.

In the embodiment shown in FIG. 8E, the helical axes 818 may be substantially perpendicular to the first surface 815-1 and/or the second surface 815-2 of the optical film 800. In other words, the helical axes 818 of the helical structures 817 may be in a thickness direction (e.g., a z-axis direction) of the optical film 800. That is, the LC molecules 812 may have substantially small tilt angles (including zero degree tilt angles), and the LC directors of the LC molecules 812 may be substantially orthogonal to the helical axis 818. The optical film 800 may have a vertical pitch Pᵥ, which may be defined as a distance along the thickness direction of the optical film 800 over which the orientations of the LC directors of the LC molecules 812 exhibit a rotation around the helical axis 818 by 180° (or the azimuthal angles of the LC directors vary by 180°). In the embodiment shown in FIG. 8E, the vertical pitch Pᵥ may be half of the helical pitch Pₕ.

As shown in FIG. 8E, the LC molecules 812 from the plurality of helical structures 817 having a first same orientation (e.g., same tilt angle and azimuthal angle) may form a first series of parallel refractive index planes 814 periodically distributed within the volume of the optical film 800. Although not labeled, the LC molecules 812 with a second same orientation (e.g., same tilt angle and azimuthal angle) different from the first same orientation may form a second series of parallel refractive index planes periodically distributed within the volume of the optical film 800. Different series of parallel refractive index planes may be formed by the LC molecules 812 having different orientations. In the same series of parallel and periodically distributed refractive index planes 814, the LC molecules 812 may have the same orientation and the refractive index may be the same. Different series of refractive index planes 814 may correspond to different refractive indices. When the number of the refractive index planes 814 (or the thickness of the birefringent medium layer) increases to a sufficient value, Bragg diffraction may be established according to the principles of volume gratings. Thus, the periodically distributed refractive index planes 814 may also be referred to as Bragg planes 814. In some embodiments, as shown in FIG. 8E, the refractive index planes 814 may be slanted with respect to the first surface 815-1 or the second surface 815-2. In some embodiments, the refractive index planes 814 may be perpendicular to or parallel with the first surface 815-1 or the second surface 815-2. Within the optical film 800, there may exist different series of Bragg planes. A distance (or a period) between adjacent Bragg planes 814 of the same series may be referred to as a Bragg period PB. The different series of Bragg planes formed within the volume of the optical film 800 may produce a varying refractive index profile that is periodically distributed in the volume of the optical film 800. The optical film 800 may diffract an input light satisfying a Bragg condition through Bragg diffraction.

As shown in FIG. 8E, the optical film 800 may also include a plurality of LC molecule director planes (or molecule director planes) 816 arranged in parallel with one another within the volume of the optical film 800. An LC molecule director plane (or an LC director plane) 816 may be a plane formed by or including the LC directors of the LC molecules 812. In the example shown in FIG. 8E, the LC directors in the LC director plane 816 have different orientations, i.e., the orientations of the LC directors vary in the x-axis direction. The Bragg plane 814 may form an angle θ with respect to the LC molecule director plane 816. In the embodiment shown in FIG. 8E, the angle θ may be an acute angle, e.g., 0°<θ<90°. The optical film 800 having the out-of-plane orientations shown in FIG. 8E may function as a transmissive PVH element, e.g., a transmissive PVH grating.

In the embodiment shown in FIG. 8F, the helical axes 818 of helical structures 817 may be tilted with respect to the first surface 815-1 and/or the second surface 815-2 of the optical film 800 (or with respect to the thickness direction of the optical film 800). For example, the helical axes 818 of the helical structures 817 may have an acute angle or obtuse angle with respect to the first surface 815-1 and/or the second surface 815-2 of the optical film 800. In some embodiments, the LC directors of the LC molecule 812 may be substantially orthogonal to the helical axes 818 (i.e., the tilt angle may be substantially zero degree). In some embodiments, the LC directors of the LC molecule 812 may be tilted with respect to the helical axes 818 at an acute angle. The optical film 800 may have a vertical periodicity (or pitch) Pᵥ. In the embodiment shown in FIG. 8F, an angle θ (not shown) between the LC director plane 816 and the Bragg plane 814 may be substantially 0° or 180°. That is, the LC director plane 816 may be substantially parallel with the Bragg plane 814. In the example shown in FIG. 8F, the orientations of the directors in the molecule director plane 816 may be substantially the same. The optical film 800 having the out-of-plane orientations shown in FIG. 8F may function as a reflective PVH element, e.g., a reflective PVH grating.

In the embodiment shown in FIG. 8G, the optical film 800 may also include a plurality of LC director planes 816 arranged in parallel within the volume of the optical film 800. In the embodiment shown in FIG. 8G, an angle θ between the LC director plane 816 and the Bragg plane 814 may be a substantially right angle, e.g., θ=90°. That is, the LC director plane 816 may be substantially orthogonal to the Bragg plane 814. In the example shown in FIG. 8G, the LC directors in the LC director plane 816 may have different orientations. In some embodiments, the optical film 800 having the out-of-plane orientations shown in FIG. 8G may function as a transmissive PVH element, e.g., a transmissive PVH grating.

In the embodiment shown in FIG. 8H, in a volume of the optical film 800, along the thickness direction (e.g., the z-axis direction) of the optical film 800, the directors (or the azimuth angles) of the LC molecules 812 may remain in the same orientation (or same angle value) from the first surface 815-1 to the second surface 815-2 of the optical film 800. In some embodiments, the thickness of the optical film 800 may be configured as d=λ/(2*Δn), where λ is a design wavelength, An is the birefringence of the LC material of the optical film 800, and Δn=nₑ−nₒ, where nₑ and nₒ are the extraordinary and ordinary refractive indices of the LC material, respectively. In some embodiments, the optical film 800 having the out-of-plane orientations shown in FIG. 8H may function as a PBP element, e.g., a PBP grating.

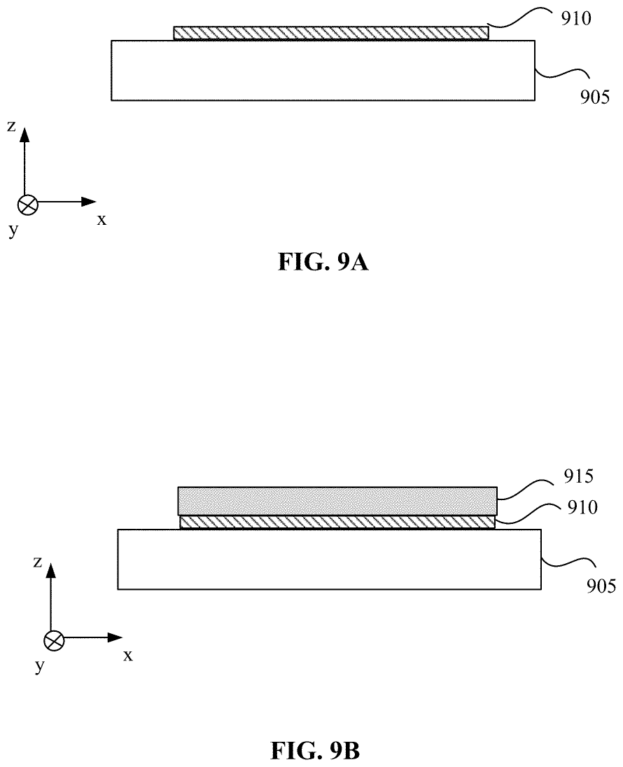

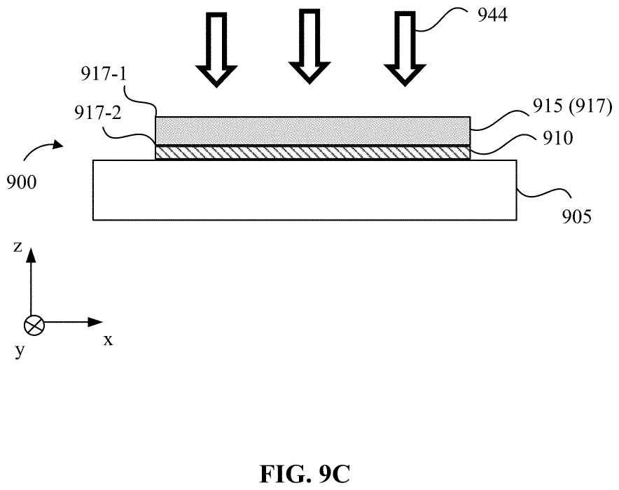

FIGS. 9A-9C schematically illustrate processes for fabricating an optical component 900, the scattering of which may be measured by the system and method disclosed herein, according to an embodiment of the present disclosure. The processes shown in FIGS. 9A-9C use a multi-layer optical component (or a layered optical component) as an example. The fabrication processes shown in FIGS. 9A-9C may include surface alignment and polymerization. For illustrative purposes, the substrate and different layers, films, or structures formed thereon are shown as having flat surfaces. In some embodiments, the substrate and different layers or films or structures may have curved surfaces. As shown in FIG. 9A, an alignment structure 910 may be formed on a surface (e.g., a top surface) of a substrate 905. The alignment structure 910 may provide an alignment pattern corresponding to a predetermined in-plane orientation pattern, such as the in-plane orientation pattern shown in FIG. 8B or FIG. 8C. The alignment structure 910 may include any suitable alignment structure, such as a photo-alignment material (“PAM”) layer, a mechanically rubbed alignment layer, an alignment layer with anisotropic nanoimprint, an anisotropic relief, or a ferroelectric or ferromagnetic material layer, etc.

In some embodiments, the alignment structure 910 may be a PAM layer, and the alignment pattern provided by the PAM layer may be formed via any suitable approach, such as holographic interference, laser direct writing, ink-jet printing, or various other forms of lithography. The PAM layer may include a polarization sensitive material (e.g., a photo-alignment material) that can have a photo-induced optical anisotropy when exposed to a polarized light irradiation. Molecules (or fragments) and/or photo-products of the polarization sensitive material may be configured to generate an orientational ordering under the polarized light irradiation. For example, the polarization sensitive material may be dissolved in a solvent to form a solution. The solution may be dispensed on the substrate 905 using any suitable solution dispensing process, e.g., spin coating, slot coating, blade coating, spray coating, or jet (ink-jet) coating or printing. The solvent may be removed from the coated solution using a suitable process, e.g., drying, or heating, thereby leaving the polarization sensitive material on the substrate 905.

The polarization sensitive material may be optically patterned via the polarized light irradiation, to form the alignment pattern corresponding to a predetermined in-plane orientation pattern. In some embodiments, the polarization sensitive material may include elongated anisotropic photo-sensitive units (e.g., small molecules or fragments of polymeric molecules). After being subjected to a sufficient exposure of the polarized light irradiation, local alignment directions of the anisotropic photo-sensitive units may be induced in the polarization sensitive material, resulting in an alignment pattern (or in-plane modulation) of an optic axis of the polarization sensitive material.

In some embodiments, an entire layer of the polarization sensitive material may be formed on the substrate via a single dispensing process, and the layer of the polarization sensitive material may be subjected to the polarized light irradiation that has a substantially uniform intensity and spatially varying orientations (or polarization directions) of linear polarizations in a predetermined space in which the entire layer of the polarization sensitive material is disposed. In some embodiments, an entire layer of the polarization sensitive material may be formed on the substrate via a plurality of dispensing processes. For example, during a first time period, a first predetermined amount of the polarization sensitive material may be dispensed at a first location of the substrate 905, and exposed to a first polarized light irradiation. During a second time period, a second predetermined amount of the polarization sensitive material may be dispensed at a second location of the substrate 905, and exposed to a second polarized light irradiation. The first polarized light irradiation may have a first uniform intensity, and a first linear polarization direction in a space in which the first predetermined amount of the polarization sensitive material is disposed. The second polarized light irradiation may have a second uniform intensity, and a second linear polarization direction in a space in which the second predetermined amount of the polarization sensitive material is disposed. The first uniform intensity and the second uniform intensity may be substantially the same. The first linear polarization direction and the second linear polarization direction may be substantially the same or different from one another. The processes may be repeated until a PAM layer that provides a desirable alignment pattern is obtained.

The substrate 905 may provide support and protection to various layers, films, and/or structures formed thereon. In some embodiments, the substrate 905 may also be transparent in the visible wavelength band (e.g., about 380 nm to about 900 nm). In some embodiments, the substrate 905 may also be at least partially transparent in at least a portion of the infrared (“IR”) band (e.g., about 900 nm to about 1 mm). The substrate 905 may include a suitable material that is at least partially transparent to lights of the above-listed wavelength ranges, such as, a glass, a plastic, a sapphire, or a combination thereof, etc. The substrate 905 may be rigid, semi-rigid, flexible, or semi-flexible. The substrate 905 may include a flat surface or a curved surface, on which the different layers or films may be formed. In some embodiments, the substrate 905 may be a part of another optical element or device (e.g., another opto-electrical element or device). For example, the substrate 905 may be a solid optical lens, a part of a solid optical lens, or a light guide (or waveguide), etc. In some embodiments, the substrate 905 may be a part of a functional device, such as a display screen.

After the alignment structure 910 is formed on the substrate 905, as shown in FIG. 9B, a birefringent medium layer 915 may be formed on the alignment structure 910 by dispensing, e.g., coating or depositing, a birefringent medium onto the alignment structure 910. The birefringent medium may have an intrinsic birefringence, and may include optically anisotropic molecules. In some embodiments, the birefringent medium may include one or more polymerizable birefringent materials, such reactive mesogens (“RMs”). RMs may be also referred to as a polymerizable mesogenic or liquid-crystalline compound, or polymerizable LCs. For discussion purposes, the term “liquid crystal molecules” or “LC molecules” may encompass both polymerizable LC molecules (e.g., RM molecules) and non-polymerizable LC molecules. For discussion purposes, in the following descriptions, RMs are used as an example of polymerizable birefringent materials, and RM molecules are used as an example of optically anisotropic molecules included in a polymerizable birefringent material. In some embodiments, polymerizable birefringent materials other than RMs may also be used.

In some embodiments, the birefringent medium may also include other ingredients, such as solvents, initiators (e.g., photo-initiators or thermal initiators), chiral dopants, or surfactants, etc. In some embodiments, the birefringent medium may not have an intrinsic or induced chirality. In some embodiments, the birefringent medium may have an intrinsic or induced chirality. For example, in some embodiments, the birefringent medium may include a host birefringent material and a chiral dopant doped into the host birefringent material at a predetermined concentration. The chirality may be introduced by the chiral dopant doped into the host birefringent material, e.g., chiral RMs doped into achiral RMs. In some embodiments, the birefringent medium may include a birefringent material having an intrinsic molecular chirality, and chiral dopants may not be doped into the birefringent material. The chirality of the birefringent medium may result from the intrinsic molecular chirality of the birefringent material. For example, the birefringent material may include chiral liquid crystal molecules, or molecules having one or more chiral functional groups.

In some embodiments, a birefringent medium may be dissolved in a solvent to form a solution. A suitable amount of the solution may be dispensed (e.g., coated, or sprayed, etc.) on the alignment structure 910 to form the birefringent medium layer 915, as shown in FIG. 9C. In some embodiments, the solution containing the birefringent medium may be coated on the alignment structure 910 using a suitable process, e.g., spin coating, slot coating, blade coating, spray coating, or jet (ink-jet) coating or printing. In some embodiments, the birefringent medium may be heated to remove the remaining solvent. This process may be referred to as a pre-exposure heating. The alignment structure 910 may provide a surface alignment to at least RM molecules that are in close proximity to (including in contact with) the alignment structure 910. For example, the alignment structure 910 may at least align the RM molecules that are in contact with the alignment structure 910 in the predetermined in-plane orientation pattern. Such an alignment procedure may be referred to as a surface-mediated alignment.

In some embodiments, when the alignment structure 910 is the PAM layer, the RM molecules in the birefringent medium may be at least partially aligned along the local alignment directions of the anisotropic photo-sensitive units in the PAM layer to form the predetermined in-plane orientation pattern. Thus, the alignment pattern formed in the PAM layer (or the in-plane orientation pattern of the optic axis of the PAM layer) may be transferred to the birefringent medium layer 915. Such an alignment procedure may be referred to as a surface-mediated photo-alignment. The photo-alignment material for a surface-mediated photo-alignment may also be referred to as a surface photo-alignment material.

In some embodiments, after the optically anisotropic molecules (e.g., RM molecules) in the birefringent medium layer 915 are aligned by the alignment structure 910, the birefringent medium layer 915 may be heat treated (e.g., annealed) in a temperature range corresponding to a nematic phase of the RMs to enhance the alignments (or orientation pattern) of the RMs (not shown in FIG. 9C). This process may be referred to as a post-exposure heat treatment (e.g., annealing). In some embodiments, the heat treatment of the birefringent medium layer 915 may be omitted.

In some embodiments, after the RMs are aligned by the alignment structure 910, the RMs may be polymerized, e.g., thermally polymerized or photo-polymerized, to solidify and stabilize the orientational pattern of the optic axis of the birefringent medium layer 915. In some embodiments, as shown in FIG. 9C, the birefringent medium layer 915 may be irradiated with, e.g., a UV light 944. Under a sufficient UV light irradiation, the RM monomers in the birefringent medium layer 915 may be polymerized or crosslinked to stabilize the orientational pattern of the optic axis of the birefringent medium layer 915. In some embodiments, the polymerization of the RM monomers under the UV light irradiation may be carried out in air, or in an inert atmosphere formed, for example, by nitrogen, argon, carbon-dioxide, or in vacuum. After the RMs are polymerized, the birefringent medium layer 915 may become an LCP layer 917, e.g., a polymerized RM layer 917. Thus, as FIG. 9C shows, the optical component 900 with a layered structure may be obtained.

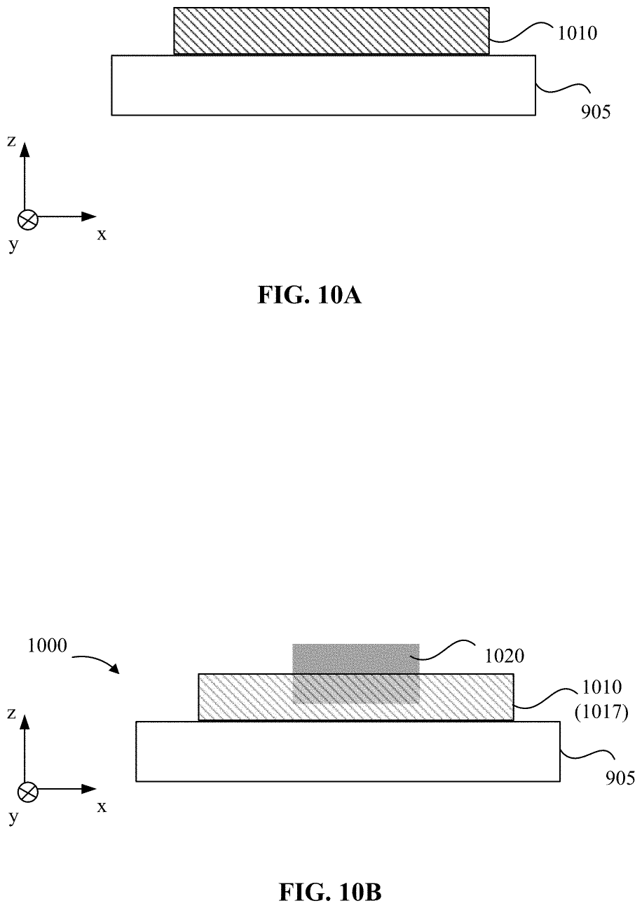

FIGS. 10A and 10B schematically illustrate processes for fabricating an optical component 1000 with layered structure, according to an embodiment of the present disclosure. The processes shown in FIGS. 10A and 10B may include dispensing (e.g., coating, depositing, ink-jet printing, etc.) a photo-sensitive polymer on a surface (e.g., a top surface) of the substrate 905 to form a photo-sensitive polymer layer 1010. In some embodiments, the photo-sensitive polymer may be mixed with other ingredients, such as a solvent in which the photo-sensitive polymer may be dissolved to form a solution, and photo-sensitizers. The solution may be dispensed on the substrate 905 using a suitable process, e.g., spin coating, slot coating, blade coating, spray coating, or jet (ink-jet) coating or printing. The solvent may be removed from the coated solution using a suitable process, e.g., drying, or heating, leaving the photo-sensitive polymer on the substrate 905.

After the photo-sensitive polymer layer 1010 is formed on the substrate 905, as shown in FIG. 10B, the photo-sensitive polymer layer 1010 may be exposed to a polarized light irradiation 1020. In some embodiments, the polarized light irradiation 1020 may have a substantially uniform intensity, and 3D spatially varying orientations (or polarization directions) of linear polarizations within a predetermined space in which the photo-sensitive polymer layer 1010 is disposed. That is, the polarized light irradiation 1020 may provide a 3D polarization field within the predetermined space in which the photo-sensitive polymer layer 1010 is disposed. In some embodiments, the polarized light irradiation 1020 may include a polarization interference pattern generated based on two coherent, circularly polarized beams with opposite handednesses. The photo-sensitive polymer layer 1010 may be optically patterned when exposed to the polarization interference pattern during the polarization interference exposure process. An orientation pattern of an optic axis of the photo-sensitive polymer layer 1010 in an exposed region may be defined during the polarization interference exposure process.

Molecules of the photo-sensitive polymer may include one or more polarization sensitive photo-reactive groups embedded in a main polymer chain or a side polymer chain. During the polarized light irradiation process of the photo-sensitive polymer layer 1010, a photo-alignment of the polarization sensitive photo-reactive groups may occur within (or in, inside) a volume of the photo-sensitive polymer layer 1010. Thus, a 3D polarization field provided by the polarized light irradiation 1020 may be directly recorded within (or in, inside) the volume of the photo-sensitive polymer layer 1010. In other words, the photo-sensitive polymer layer 1010 may be optically patterned to form a patterned photo-sensitive polymer layer (referred to as 1017 in FIG. 10B for discussion purpose). Such an alignment procedure shown in FIG. 10B may be referred to as a bulk-mediated photo-alignment. The photo-sensitive polymer included in the photo-sensitive polymer layer 1010 for a bulk-mediated photo-alignment shown in FIG. 10B may also be referred to as a volume recording medium or bulk PAM. The photo-sensitive polymer layer 1010 for a bulk-mediated photo-alignment shown in FIG. 10B may be relatively thicker than the PAM layer (e.g., 910) for a surface-mediated photo-alignment shown in FIGS. 9A-9C. Thus, as FIG. 10B shows, the optical component 1000 with a layered structure may be obtained.

In some embodiments, the photo-sensitive polymer included in the photo-sensitive polymer layer 1010 may include an amorphous polymer, an LC polymer, etc. The molecules of the photo-sensitive polymer may include one or more polarization sensitive photo-reactive groups embedded in a main polymer chain or a side polymer chain. In some embodiments, the polarization sensitive photo-reactive group may include an azobenzene group, a cinnamate group, or a coumarin group, etc. In some embodiments, the photo-sensitive polymer may be an amorphous polymer, which may be initially optically isotropic prior to undergoing the polarized light irradiation 1020, and may exhibit an induced (e.g., photo-induced) optical anisotropy after being subjected to the polarized light irradiation 1020. In some embodiments, the photo-sensitive polymer may be an LC polymer, in which the birefringence and in-plane orientation pattern may be recorded due to an effect of photo-induced optical anisotropy. In some embodiments, the photo-sensitive polymer may be an LC polymer with a polarization sensitive cinnamate group embedded in a side polymer chain. In some embodiments, when the photo-sensitive polymer layer 1010 includes an LC polymer, the patterned photo-sensitive polymer layer 1017 may be heat treated (e.g., annealed) in a temperature range corresponding to a liquid crystalline state of the LC polymer to enhance the photo-induced optical anisotropy of the LC polymer (not shown in FIG. 10B).

Referring to FIGS. 9A-10B, in some embodiments, the fabrication process of the optical component 900 or 1000 with a layered structure may include additional steps. For example, in some embodiments, the fabrication process may also include forming a protecting film (e.g., a TAC film) on the LCP layer 917 or patterned photo-sensitive polymer layer 1017 for protection purposes. In some embodiments, the fabrication process may also include disposing a cover glass on the protecting film. In some embodiments, the optical component 900 fabricated based on the fabrication processes shown in FIGS. 9A-9C and the optical component 1000 fabricated based on the fabrication processes shown in FIGS. 10A and 10B may be a liquid crystal polarization hologram (“LCPH”) component or device. For discussion purpose, in the present disclosure, the term “LCPH” may encompass polarization holograms based on LCs and polarization holograms based on birefringent photo-refractive holographic materials other than LCs (e.g., an amorphous polymer). The LCPH component may be a reflective optical component or a transmissive optical component, such as a PBP component, a reflective PVH component, or a transmissive PVH component. In some embodiments, the optical component 900 fabricated based on the fabrication processes shown in FIGS. 9A-9C and the optical component 1000 fabricated based on the fabrication processes shown in FIGS. 10A and 10B may be a passive LCPH element.

After the optical component 900 or 1000 is fabricated, the scattering property of the optical component 900 or 1000 may be tested using the system 400 disclosed herein. Based on the measured overall scattering and the methods described above, the respective contributions of the volumetric scattering and the surface scattering provided by various components of the optical component 900 or 1000 may be determined. Guidance may be provided based on the respective contributions. For example, when the volumetric scattering constitutes the primary contribution to the overall scattering, guidance may be provided to adjust the material formulation of the optical component 900 or 1000 to reduce the overall scattering. When the surface scattering constitutes the primary contribution to the overall scattering, guidance may be provided to polish the surfaces or apply other types of surface treatment to the surfaces to reduce the overall scattering.

In some embodiments, the present disclosure provides a system that includes a light source configured to emit a probing beam to illuminate an optical element. The system also includes a rotating structure to which the optical element is mounted. The system also includes a controller configured to control the rotating structure to rotate to change a tilt angle of the optical element with respect to a propagation direction of the probing beam within a predetermined tilting range. The system also includes an image sensor configured to receive one or more scattered beams output from the optical element illuminated by the probing beam, and generate a plurality of sets of speckle pattern image data when the optical element is arranged at a plurality of tilt angles within the predetermined tilting range. The controller is configured to process the plurality of sets of speckle pattern image data to determine respective weights of volumetric scattering and surface scattering in an overall scattering of the optical element.

In some embodiments, the image sensor is a camera sensor. In some embodiments, a position of the image sensor is fixed as the optical element is rotated to the respective tilt angles. In some embodiments, the controller is configured to process the plurality of sets of speckle pattern image data to determine a first weight of the surface scattering in the overall scattering of the optical element, and determine a second weight of the volumetric scattering in the overall scattering of the optical element based on the first weight of the surface scattering.

In some embodiments, for each set of speckle pattern image data associated with each tilt angle, the controller is configured to determine a correlation function of the set of speckle pattern image data with respect to a set of reference speckle pattern image data. In some embodiments, for each correlation function associated with each tilt angle, the controller is configured to determine a maximum correlation coefficient of the correlation function. In some embodiments, the controller is configured to determine, based on a plurality of maximum correlation coefficients associated with the plurality of tilt angles of the optical element, a tilt angle dependent correlation profile of the optical element, the tilt angle dependent correlation profile representing a relationship between the maximum correlation coefficients and the tilt angles.

In some embodiments, the optical element includes a surface scattering source that generates the surface scattering and a volumetric scattering source that generates the volumetric scattering, and the controller is configured to determine, based on the tilt angle dependent correlation profile, at least one tilt angle that is representative of a memory effect range of at least one of the surface scattering source or the volumetric scattering source.

In some embodiments, the controller is configured to determine, based on the at least one tilt angle that is representative of the memory effect range, respective weights of the surface scattering and the volumetric scattering in an overall scattering of the optical element.

In some embodiments, based on a plurality of maximum correlation coefficients associated with the plurality of tilt angles of the optical element, the controller is configured to: determine a first tilt angle from which the maximum correlation coefficient is smaller than a predetermined coefficient value.

In some embodiments, the controller is configured to: determine, based on a plurality of maximum correlation coefficients associated with the plurality of tilt angles of the optical element, a tilt angle dependent correlation profile of the optical element, the tilt angle dependent correlation profile representing a relationship between the maximum correlation coefficients and the tilt angles; and determine a second tilt angle based on the tilt angle dependent correlation profile of the optical element.

In some embodiments, the controller is configured to: determine a first weight of the surface scattering as the maximum correlation coefficient corresponding to the first tilt angle or as an average of the maximum correlation coefficients corresponding to a sub-range of tilt angles selected between the first tilt angle and the second tilt angle; and determine a second weight of the volumetric scattering as a difference between a maximum value of the plurality of maximum correlation coefficients and the first weight.

In some embodiments, the controller is configured to determining a plurality of exposure times of the imaging sensor for the plurality of tilt angles of the optical element. In some embodiments, with a light source that emits the probing beam turned on, the controller is configured to rotate the rotating structure to change the tilt angle of the optical element within the predetermined tilting range, and the image sensor is configured to generate each set of speckle pattern image data using an exposure time associated with each tilt angle.

In some embodiments, the present disclosure provides a method. The method includes illuminating, by a light source, an optical element mounted to a rotating structure with a probing beam. The method also includes controlling, by a controller, rotation of the rotating structure to change a tilt angle of the optical element with respect to a propagation direction of the probing beam within a predetermined tilting range. The method also includes generating, by an image sensor, a plurality of sets of speckle pattern image data when the optical element is arranged at a plurality of tilt angles within the predetermined tilting range. The method also includes processing, by the controller, the plurality of sets of speckle pattern image data to determine respective weights of volumetric scattering and surface scattering in an overall scattering of the optical element.

In some embodiments, processing, by the controller, the plurality of sets of speckle pattern image data to determine the respective weights of volumetric scattering and surface scattering in the overall scattering of the optical element includes: determining a first weight of the surface scattering in the overall scattering of the optical element; and determining a second weight of the volumetric scattering in the overall scattering of the optical element based on the first weight of the surface scattering.

In some embodiments, processing, by the controller, the plurality of sets of speckle pattern image data to determine the respective weights of volumetric scattering and surface scattering in the overall scattering of the optical element includes: for each set of speckle pattern image data corresponding to each tilt angle, determining a correlation function of the set of speckle pattern image data with respect to a set of reference speckle pattern image data; for each correlation function associated with each tilt angle, determining a maximum correlation coefficient of the correlation function, thereby obtaining a plurality of maximum correlation coefficients for the plurality of tilt angles; and determining a first tilt angle corresponding to which the maximum correlation coefficient is smaller than a predetermined coefficient value.

In some embodiments, the method also includes determining, based on the plurality of maximum correlation coefficients associated with the plurality of tilt angles of the optical element, a tilt angle dependent correlation profile of the optical element, the tilt angle dependent correlation profile representing a relationship between the maximum correlation coefficients and the tilt angles; and determining a second tilt angle based on the tilt angle dependent correlation profile of the optical element.

In some embodiments, processing, by the controller, the plurality of sets of speckle pattern image data to determine the respective weights of volumetric scattering and surface scattering in the overall scattering of the optical element also includes determining the first weight of the surface scattering as the maximum correlation coefficient corresponding to the first tilt angle or as an average of the maximum correlation coefficients corresponding to a sub-range of tilt angles selected between the first tilt angle and the second tilt angle; and determining the second weight of the volumetric scattering as a difference between a maximum value of the plurality of maximum correlation coefficients and the first weight.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A system, comprising:
a light source configured to emit a probing beam to illuminate an optical element;
a rotating structure to which the optical element is mounted;
a controller configured to control the rotating structure to rotate to change a tilt angle of the optical element with respect to a propagation direction of the probing beam within a predetermined tilting range; and
an image sensor configured to receive one or more scattered beams output from the optical element illuminated by the probing beam, and generate a plurality of sets of speckle pattern image data when the optical element is arranged at a plurality of tilt angles within the predetermined tilting range,
wherein the controller is configured to process the plurality of sets of speckle pattern image data to determine respective weights of volumetric scattering and surface scattering in an overall scattering of the optical element.

2. The system of claim 1, wherein the image sensor is a camera sensor.

3. The system of claim 1, wherein a position of the image sensor is fixed as the optical element is rotated to the respective tilt angles.

4. The system of claim 1, wherein the controller is configured to process the plurality of sets of speckle pattern image data to determine a first weight of the surface scattering in the overall scattering of the optical element, and determine a second weight of the volumetric scattering in the overall scattering of the optical element based on the first weight of the surface scattering.

5. The system of claim 1, wherein for each set of speckle pattern image data associated with each tilt angle, the controller is configured to determine a correlation function of the set of speckle pattern image data with respect to a set of reference speckle pattern image data.

6. The system of claim 5, wherein for each correlation function associated with each tilt angle, the controller is configured to determine a maximum correlation coefficient of the correlation function.

7. The system of claim 6, wherein the controller is configured to determine, based on a plurality of maximum correlation coefficients associated with the plurality of tilt angles of the optical element, a tilt angle dependent correlation profile of the optical element, the tilt angle dependent correlation profile representing a relationship between the maximum correlation coefficients and the tilt angles.

8. The system of claim 7, wherein:
the optical element includes a surface scattering source that generates the surface scattering and a volumetric scattering source that generates the volumetric scattering, and
the controller is configured to determine, based on the tilt angle dependent correlation profile, at least one tilt angle that is representative of a memory effect range of at least one of the surface scattering source or the volumetric scattering source.

9. The system of claim 8, wherein the controller is configured to determine, based on the at least one tilt angle that is representative of the memory effect range, respective weights of the surface scattering and the volumetric scattering in the overall scattering of the optical element.

10. The system of claim 6, wherein based on a plurality of maximum correlation coefficients associated with the plurality of tilt angles of the optical element, the controller is configured to:
determine a first tilt angle from which the maximum correlation coefficient is smaller than a predetermined coefficient value.

11. The system of claim 10, wherein the controller is configured to:
determine, based on a plurality of maximum correlation coefficients associated with the plurality of tilt angles of the optical element, a tilt angle dependent correlation profile of the optical element, the tilt angle dependent correlation profile representing a relationship between the maximum correlation coefficients and the tilt angles; and
determine a second tilt angle based on the tilt angle dependent correlation profile of the optical element.

12. The system of claim 11, wherein the controller is configured to:
determine a first weight of the surface scattering as the maximum correlation coefficient corresponding to the first tilt angle or as an average of the maximum correlation coefficients corresponding to a sub-range of tilt angles selected between the first tilt angle and the second tilt angle; and
determine a second weight of the volumetric scattering as a difference between a maximum value of the plurality of maximum correlation coefficients and the first weight.

13. The system of claim 1, wherein the controller is configured to determining a plurality of exposure times of the imaging sensor for the plurality of tilt angles of the optical element.

14. The system of claim 13, wherein:
with a light source that emits the probing beam turned on, the controller is configured to rotate the rotating structure to change the tilt angle of the optical element within the predetermined tilting range, and
the image sensor is configured to generate each set of speckle pattern image data using an exposure time associated with each tilt angle.

15. A method, comprising:
illuminating, by a light source, an optical element mounted to a rotating structure with a probing beam;
controlling, by a controller, rotation of the rotating structure to change a tilt angle of the optical element with respect to a propagation direction of the probing beam within a predetermined tilting range;
generating, by an image sensor, a plurality of sets of speckle pattern image data when the optical element is arranged at a plurality of tilt angles within the predetermined tilting range; and
processing, by the controller, the plurality of sets of speckle pattern image data to determine respective weights of volumetric scattering and surface scattering in an overall scattering of the optical element.

16. The method of claim 15, wherein a position of the image sensor is fixed as the optical element is rotated to the respective tilt angles.

17. The method of claim 15, wherein processing, by the controller, the plurality of sets of speckle pattern image data to determine the respective weights of volumetric scattering and surface scattering in the overall scattering of the optical element includes:
determining a first weight of the surface scattering in the overall scattering of the optical element; and
determining a second weight of the volumetric scattering in the overall scattering of the optical element based on the first weight of the surface scattering.

18. The method of claim 17, wherein processing, by the controller, the plurality of sets of speckle pattern image data to determine the respective weights of volumetric scattering and surface scattering in the overall scattering of the optical element includes:
for each set of speckle pattern image data corresponding to each tilt angle, determining a correlation function of the set of speckle pattern image data with respect to a set of reference speckle pattern image data;
for each correlation function associated with each tilt angle, determining a maximum correlation coefficient of the correlation function, thereby obtaining a plurality of maximum correlation coefficients for the plurality of tilt angles; and
determining a first tilt angle corresponding to which the maximum correlation coefficient is smaller than a predetermined coefficient value.

19. The method of claim 17, further comprising:
determining, based on the plurality of maximum correlation coefficients associated with the plurality of tilt angles of the optical element, a tilt angle dependent correlation profile of the optical element, the tilt angle dependent correlation profile representing a relationship between the maximum correlation coefficients and the tilt angles; and
determining a second tilt angle based on the tilt angle dependent correlation profile of the optical element.

20. The method of claim 19, further comprising:
determining the first weight of the surface scattering as the maximum correlation coefficient corresponding to the first tilt angle or as an average of the maximum correlation coefficients corresponding to a sub-range of tilt angles selected between the first tilt angle and the second tilt angle; and
determining the second weight of the volumetric scattering as a difference between a maximum value of the plurality of maximum correlation coefficients and the first weight.
